(19) United States
(12) Patent Application Publication
(10) Pub. No.: US 2010/0126377 A1
(43) Pub. Date: May 27, 2010

(54) PORPHYRAZINE COLORING MATTER AND INK CONTAINING THE SAME

(75) Inventors: Takashi Yoneda, Tokyo (JP); Takafumi Fujii, Tokyo (JP); Shinsuke Shimizu, Tokyo (JP); Hirokazu Kitayama, Tokyo (JP)

Correspondence Address: Nields, Lemack & Frame, LLC, 176 E. Main Street, Suite #5, Westborough, MA, 01581, US

(73) Assignee: Nippon Kayaku Kabushiki Kaisha, Chiyoda-ku, Tokyo (JP)

(21) Appl. No.: 12/452,102

(22) PCT Filed: Jul. 3, 2008
(86) PCT No.: PCT/JP2008/062067

§ 371 Date: Dec. 15, 2009

(30) Foreign Application Priority Data
Jul. 5, 2007 (JP) 2007-177236

(51) Int. Cl. C09B 47/04; C09D 11/02; B05D 5/00

(52) U.S. Cl. 106/31.49; 427/256; 540/130

(57) ABSTRACT

The present invention relates to an ink composition containing a phthalocyanine coloring matter represented by the following formula (1):

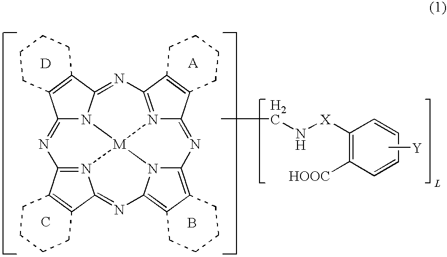

(wherein, each of the rings A to D independently represents a benzene ring or a pyridine ring, M represents a metal atom or the like, X represents a carbonyl group or the like, Y represents a hydrogen atom; a nitro group; a hydroxy group; a sulfo group; a carboxy group; an amino group; an alkoxy group, an alkylthio group, an alkylsulfonyl group which may be substituted; an aryloxy group, an arylthio group, an arylsulfonyl group, a heteroaryloxy group, a heteroarylthio group, a heteroarylsulfonyl group or an amino group, which may be substituted; or the like, and L is from 2 to 8) or a salt thereof; and said ink composition gives, in inkjet printing on plain paper, printed matters exhibiting an extremely excellent water fastness.

### TECHNICAL FIELD

The present invention relates to a water-soluble porphyrazine coloring matter or a salt thereof, an ink composition containing it and a colored product therewith.

### BACKGROUND ART

As for the recording method by means of an inkjet printer which is one of the typical methods among various color recording methods, various methods for discharging ink have been developed, and in any of the methods, ink droplets are generated and adhered onto various record-receiving materials (such as paper, film and cloth) to perform recording. This method has been rapidly prevailing lately and is expected to continue growing remarkably in the future because of features such as quietness without noise generation due to no direct contact of a recording head with a record-receiving material and as easiness in downsizing, speeding up and colorizing. Conventionally, as an ink for fountain pens, felt-tip pens or the like and as an ink for inkjet recording, inks where a water-soluble dye is dissolved in an aqueous medium have been used, and in these water-based inks, a water-soluble organic solvent is generally added to prevent ink from clogging at a pen tip or an inkjet nozzle. These inks are required to provide recorded images with sufficient density, not to clog at a pen tip or a nozzle, to dry quickly on a record-receiving material, to bleed less, to have excellent storage stability, and so on. In addition, recorded images formed are required to have fastnesses such as water fastness, moisture fastness, light fastness and gas fastness.

Clogging at the nozzle of an inkjet is often due that water in an ink evaporates in the vicinity of the nozzle before the other solvent and additive do, resulting in the compositional condition that water remains less while the other solvent and additive remain more whereby the coloring matter crystallizes and precipitates. Therefore, it is one of the very important performances required that crystals hardly precipitate even when the ink is dried by evaporation. In addition, for this reason, high solubility in solvents and additives is one of the properties required for coloring matters.

Meanwhile, in order that images or character information on a color display of a computer are recorded in color by an ink jet printer, subtractive color mixture of 4 color inks of yellow (Y), magenta (M), cyan (C) and black (K) is generally used, by which recorded images are expressed in color. In order that images by additive color mixture of red (R), green (G) and blue (B) on CRT (cathode ray tube) displays and the like are, as faithfully as possible, reproduced with images by subtractive color mixture, it is desired that coloring matters to be used for inks, particularly Y, M and C, have respectively a hue close to each standard and also are vivid. In addition, it is required that the inks are stable in storage for a long period of time, and that images printed as the above have a high concentration and also the printed images are excellent in fastnesses.

With the recent development of the inkjet techniques, improvement of printing speed is remarkable and there is a move to use an inkjet printer, as well as a laser printer using an electronic toner, for document printing on plain paper which is a major application in the office environment. The inkjet printer has some such advantages that there is no need to select the recording paper type and inkjet printers are comparatively inexpensive, and therefore it is becoming widespread particularly in small to medium scale office environments such as SOHO. When an inkjet printer is thus used for application of printing on plain paper, there is a tendency that hue and water fastness are more emphasized among the qualities required for printed matters. In order to satisfy these performances, a method using a pigment ink has been proposed. However, since pigment ink is not a solution but a dispersion liquid which disperse a solid pigment in a liquid, using pigment ink relatively tends to cause such problems that the stability of the ink is poor and the nozzle of a printer head is clogged. In addition, when a pigment ink is used, the low abrasion resistance of printed images is often regarded as a problem, too. It is said that dye ink relatively hardly poses problems because it is such a pigment ink. However, dye ink is significantly inferior in water fastness compared with pigment ink, whereby improvement thereof is strongly desired.

Many proposals have been made to the problem of improvement of water fastness on plain paper through the ages. As a blue coloring matter for inkjet which is excellent in water fastness and whose hue and light fastness are improved, for example, C.I.Direct Blue 86 and C.I.Direct Blue 199 described in Patent Literature 1 are proposed.

Patent Literature 2 discloses a pigment composition comprising carbon black and a phthalocyanine derivative.

Patent Literature 3 discloses a method for producing dimethyl aminomethyl copper phthalocyanine and a derivative thereof.

### Patent Literature 1: JP 2001-294786 A

### Patent Literature 2: JP S58-167654 A

### Patent Literature 3: JP S62-135568 A

### DISCLOSURE OF THE INVENTION

### Problems to Be Solved by the Invention

As for the dye described in Patent Literature 1, the water fastness thereof is excellent on certain kinds of plain paper but it cannot be said that it is excellent on various kinds of plain paper available on the market, whereby the applicable range is narrow. Therefore, a cyan coloring matter which has an excellent water fastness uniformly on more kinds of plain paper and is also excellent in light fastness, hue and color density has been required.

It is an object of the present invention to provide a water-soluble cyan coloring matter which has a high solubility in water or a water-soluble organic solvent, hue and vividness suitable for inkjet recording and a high color density, and allows excellent fastnesses, such as light fastness, gas fastness, moisture fastness and particularly water fastness, of recorded matter, and to provide an ink composition containing it which has a good storage stability.

### Means of Solving the Problems

The present inventors have intensively studied to solve the above problems and found that a water-soluble porphyrazine coloring matter represented by a particular formula and an ink composition containing it can solve the above problems, and have completed the present invention.

That is, the present invention relates to:

(1) An ink composition containing a coloring matter represented by the following formula (1) or a salt thereof:

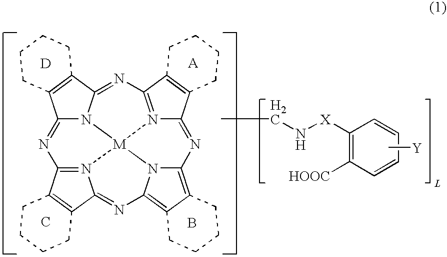

(wherein, each of the rings A to D shown with dotted lines independently represents a benzene ring or a pyridine ring, and at least one or more thereof is a benzene ring,
M represents a hydrogen atom, a metal atom, a metal oxide, a metal hydroxide or a metal halide,
X represents a carbonyl group or a sulfonyl group,
Y represents a hydrogen atom; a nitro group; a hydroxy group; a sulfo group; a carboxy group; an amino group (which may have, as a substituent, one or more kinds of groups selected from the group consisting of an aryl group, a heteroaryl group, an alkyl group, an alkoxy group, an alkylsulfonyl group, an alkylthio group, an arylamino group, a diarylamino group, a heteroarylamino group, a diheteroarylamino group, an alkylamino group, a dialkylamino group, a sulfo group, a carboxy group, a phosphono group, a sulfamoyl group, a carbamoyl group, a hydroxy group, an amino group, an acetylamino group, an ureide group, a nitro group, a cyano group and a halogen atom); a group selected from the group consisting of an alkoxy group, an alkylthio group and an alkylsulfonyl group, which may have, as a substituent, one or more kinds of groups selected from the group consisting of an aryl group, a heteroaryl group, an alkoxy group, an alkylsulfonyl group, an alkylthio group, an arylamino group, a diarylamino group, a heteroarylamino group, a diheteroarylamino group, an alkylamino group, a dialkylamino group, a sulfo group, a carboxy group, a phosphono group, a sulfamoyl group, a carbamoyl group, a hydroxy group, an amino group, an acetylamino group, an ureide group, a nitro group, a cyano group and a halogen atom; or a group selected from the group consisting of an aryloxy group, an arylthio group, an arylsulfonyl group, a heteroaryloxy group, a heteroarylthio group and a heteroarylsulfonyl group, which may be substituted by one or more kinds of substituents selected from the group consisting of an alkyl group, an alkoxy group, an alkylsulfonyl group, an alkylthio group, an arylamino group, a diarylamino group, a heteroarylamino group, a diheteroarylamino group, an alkylamino group, a dialkylamino group, a sulfo group, a carboxy group, a phosphono group, a sulfamoyl group, a carbamoyl group, a hydroxy group, an amino group, an acetylamino group, an ureide group, a nitro group, a cyano group and an a halogen atom, as a substituent, and
L is from 2 to 8,
respectively),
(2) The ink composition according to (1), wherein the coloring matter represented by the formula (1) or a salt thereof is a coloring matter represented by the following formula (111) or a salt thereof:

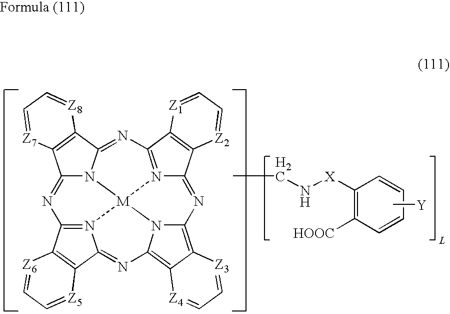

(wherein, M represents a hydrogen atom, a metal atom, a metal oxide, a metal hydroxide or a metal halide,
X denotes a carbonyl group or a sulfonyl group,
Y represents a hydrogen atom or a carboxy group,
L is from 2 to 8,
each of Z₁ to Z₈ independently represents a nitrogen atom or a carbon atom, where at least one of the four combinations, Z₁ and Z₂, Z₃ and Z₄, Z₅ and Z₆ and, Z₇ and Z₈, is a combination of carbon atoms and none of the above combinations is a combination of nitrogen atoms),
(3) The ink composition containing the coloring matter or a salt thereof according to (1) or (2), wherein M is a copper atom,
(4) The ink composition according to any one of (1) to (3), which further contains an organic solvent,
(5) The ink composition according to any one of (1) to (4), which is for inkjet recording,
(6) An inkjet recording method characterized by using the ink composition according to any one of (1) to (5) as an ink or using an ink set comprising the ink composition in an inkjet recording method in which an ink drop is discharged responding to a recording signal to carry out recording on a record-receiving material,
(7) The inkjet recording method according to (6), wherein the record-receiving material is a communication sheet,
(8) An ink container containing the ink composition according to any one of (1) to (5),
(9) An inkjet printer having the ink container according to (8),
(10) A colored product colored with the ink composition according to any one of (1) to (5),
(11) A coloring matter represented by the following formula (2) or a salt thereof:

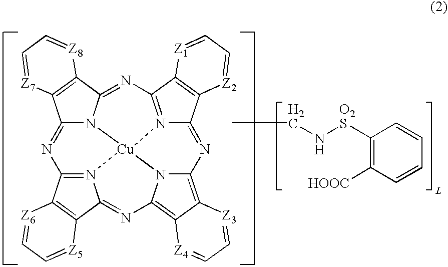

(wherein, L is from 2 to 8,
each of Z₁ to Z₈ independently represents a nitrogen atom or a carbon atom, where at least one of the four combinations, Z₁ and Z₂, Z₃ and Z₄, Z₅ and Z₆, and Z₇ and Z₈, is a combination of carbon atoms and none of the above combinations is a combination of nitrogen atoms),
(12) The ink composition containing the coloring matter according to (11) or a salt thereof,
(13) The ink composition according to (11), which further contains an organic solvent,
(14) A colored product colored with the coloring matter according to (11) or a salt thereof or with the ink composition according to (12) or (13).

### EFFECT OF THE INVENTION

The water-soluble porphyrazine coloring matter represented by the above formula (1) of the present invention or a salt thereof has an excellent solubility in water and a water-soluble organic solvent. It has a characteristic of, for example, the good filterability through a membrane filter in the process of producing the ink composition and gives a very vivid hue of cyan color on inkjet recording paper. In addition, the ink composition of the present invention containing this compound has no crystal precipitation or no change in physical properties, hue and the like after storage for a long period of time, and thus the storage stability thereof is extremely good. And when inkjet recording is carried out using the ink composition of the present invention, an ideal cyan color hue can be obtained on various record-receiving materials without selecting a record-receiving material (for example, paper, film and the like), and it is also possible that photo-like color images are faithfully reproduced on paper.

In addition, the ink composition of the present invention has an extremely improved water fastness on plain paper, compared with conventional dye inks. Further, when recording is carried out on a record-receiving material whose surface is coated with a porous white inorganic substance, such as inkjet special paper and film for photo image quality, the ink composition of the present invention has various good fastnesses, i.e. water fastness, moisture fastness, gas fastness and light fastness, and allows excellent long-term storage stability of the photo-like recorded images. Therefore, not selecting recording media is one of the characteristics of the ink composition of the present invention and it can be said that the ink composition of the present invention is very suitable for inkjet printing.

As described above, the water-soluble porphyrazine coloring matter of the above formula (1) is extremely useful as a cyan coloring matter for ink, particularly for an ink for inkjet recording.

### BEST MODE FOR CARRYING OUT THE INVENTION

The present invention will be specifically explained.

In the present invention, the following terms are used in the meaning described below unless otherwise noted.

The term “aryl” includes any included in aryl, but usually means an aryl group having 6 to 14 carbon atoms, preferably 6 to 12 and more preferably 6 to 10.

The term “heteroaryl” includes any included in heteroaryl, but usually means a heteroaryl group having 3 to 9 carbon atoms, preferably 3 to 8 carbon atoms and more preferably 4 to 5 carbon atoms, which comprises 1 to 2 of each of a nitrogen atom, an oxygen atom or a sulfur atom, independently as a ring-constituting atom. The ring constituting said heteroaryl group is preferably a 4 to 6-membered ring and more preferably a 5 to 6-membered ring. The group is preferably formed by 1 to 3, preferably 1 or 2 and more preferably 1 of them, and a 6-membered ring is more preferable.

The term “alkyl” includes any included in alkyl, but usually means alkyl having 1 to 16 carbon atoms, preferably 1 to 12 carbon atoms, more preferably 1 to 6 carbon atoms and further preferably 1 to 4 carbon atoms, and it may be any of linear, branched and cyclic, but preferably linear or branched and further preferably linear.

The term “alkoxy” is used in referring to “alkyl oxy”, and alkyl has the same meaning as described above.

The ink suitable for inkjet recording of the present invention is characterized by containing the porphyrazine coloring matter of the above formula (1). That is, the present invention has been completed by finding that the coloring matter where phthalocyanine or azaphthalocyanine (which is, usually, a coloring matter where 1 to 3 ring out of 4 benzo (benzene) rings of a coloring matter referred to as phthalocyanine is replaced by a hetero 6-membered ring comprising a nitrogen atom, usually by a pyridine ring) is used as the mother nucleus of the coloring matter and an o-carboxy-substituted benzamide methyl group or an o-carboxy-substituted benzenesulfonamide methyl group (which may further have a substituent on the benzene ring) are introduced there, is very suitable for an ink for inkjet, and that images recorded with said ink are also extremely excellent in water fastness.

In the above formula (1), each of the rings A to D shown with dotted lines (hereinafter, referred to as the rings A to D for simplicity) independently represents a benzene ring or a pyridine ring and at least one or more thereof is a benzene ring,

M represents a hydrogen atom, a metal atom, a metal oxide, a metal hydroxide or a metal halide,
X represents a carbonyl group or a sulfonyl group,
Y represents a hydrogen atom; a nitro group; a hydroxy group; a sulfo group; a carboxy group; an amino group (which may have, as a substituent, one or more kinds of groups selected from the group consisting of an aryl group, a heteroaryl group, an alkyl group, an alkoxy group, an alkylsulfonyl group, an alkylthio group, an arylamino group, a diarylamino group, a heteroarylamino group, a diheteroarylamino group, an alkylamino group, a dialkylamino group, a sulfo group, a carboxy group, a phosphono group, a sulfamoyl group, a carbamoyl group, a hydroxy group, an amino group, an acetylamino group, an ureide group, a nitro group, a cyano group and a halogen atom); a group selected from the group consisting of an alkoxy group, an alkylthio group and an alkylsulfonyl group, which may be substituted by one or more kinds of groups selected from the group consisting of an aryl group, a heteroaryl group, an alkoxy group, an alkylsulfonyl group, an alkylthio group, an arylamino group, a diarylamino group, a heteroarylamino group, a diheteroarylamino group, an alkylamino group, a dialkylamino group, a sulfo group, a carboxy group, a phosphono group, a sulfamoyl group, a carbamoyl group, a hydroxy group, an amino group, an acetylamino group, an ureide group, a nitro group, a cyano group, and a halogen atom, as a substituent; and a group selected from the group consisting of an aryloxy group, an arylthio group, an arylsulfonyl group, a heteroaryloxy group, a heteroarylthio group and a heteroarylsulfonyl group, which may be substituted by one or more kinds of groups selected from the group consisting of an alkyl group, an alkoxy group, an alkylsulfonyl group, an alkylthio group, an arylamino group, a diarylamino group, a heteroarylamino group, a diheteroarylamino group, an alkylamino group, a dialkylamino group, a sulfo group, a carboxy group, a phosphono group, a sulfamoyl group, a carbamoyl group, a hydroxy group, an amino group, an acetylamino group, an ureide group, a nitro group, a cyano group and an a halogen atom as a substituent, and
L is from 2 to 8.

From 0 to 3 of the above rings A to D is pyridine and the rest are benzene. As the number of pyridine is increased, water fastness is improved but solubility in water, an organic solvent and the like tends to be reduced. For this reason, the number of pyridine is appropriately controlled in view of water fastness and solubility, and thus a balanced ratio can be selected. The number of pyridine is, as an average value, usually in the range of preferably 0 to 2, more preferably 0 to 1.5, further preferably 0 to 1.25 and most preferably 0. The rest are benzene rings. For example, when the number of pyridine rings is more than 1 and less than 2, the compound is a mixture of a compound containing 1 pyridine and a compound containing 2 pyridines, and it means that the number of pyridine as an average value in the mixture is in the above range. When 2 of the rings A to D are pyridines, it is considered that the compound is a mixture of a compound in which 2 pyridine rings are placed next to each other (for example, in A and B) and a compound in which 2 pyridine rings are placed in diagonal position (for example in A and C). When the compound is described by using its structural formula in the explanation of the production method or in the examples, a structural formula of the compound in which 2 of A and C are pyridine rings and B and C are benzene rings is described for convenience, unless otherwise noted, which stands for both the compounds described above (usually, a mixture of the both compounds), because it is complicated and confusing to describe all the structures and also it is unnecessary to bother distinguishing them in the present invention.

The above M represents a hydrogen atom, a metal atom, a metal oxide, a metal hydroxide or a metal halide.

Specific examples of the metal atom include, for example, Li, Na, K, Mg, Ti, Zr, V, Nb, Ta, Cr, Mo, W, Mn, Fe, Co, Ni, Ru, Rh, Pd, Os, Ir, Pt, Cu, Ag, Au, Zn, Cd, Hg, Al, Ga, In, Si, Ge, Sn, Pb, Sb, Bi and the like.

The metal oxide includes VO, GeO and the like.

The metal hydroxide includes, for example, Si(OH)₂, Cr(OH)₂, Sn(OH)₂, AlOH and the like.

The metal halide includes, for example, SiCl₂, VCl, VCl₂, VOCl, FeCl, GaCl, ZrCl, AlCl and the like.

Among them, Cu, Ni, Zn, Al and AlOH are preferable and Cu is the most preferable.

The above X denotes a carbonyl group or a sulfonyl group, and sulfonyl is preferable in terms of hue of cyan coloring matter.

When the above Y is an alkoxy group having no substituent, said alkoxy group may be linear, branched or cyclic, but it is preferably linear or branched and further preferably linear. The carbon atom number is 1 to 16, preferably 1 to 12, more preferably 1 to 6, and further preferably 1 to 4.

When Y is a cyclic alkoxy group, said alkoxy group forms a polycyclic structure where a Y-substituted benzene ring is fused. As this example, preferable is ring structures of 2- or 3-coumaranone type and 2-, 3- or 4-chromanone type bicyclo[4,3,0] and bicyclo[4,4,0], and the like.

Specific examples of the alkoxy group include methoxy, ethoxy, propoxy, butoxy, pentyloxy, hexyloxy, octyloxy, nonyloxy, decyloxy, undecyloxy, dodecyloxy, tridecyloxy, tetradecyloxy, pentadecyloxy, hexadecyloxy and the like.

When the above Y is an alkylthio group having no substituent, said alkylthio group can be explained in the same way as in the above explanation of “alkoxy group having no substituent”, except for oxygen atom is replaced by sulfur atom. That is, said alkylthio group may be any of linear, branched and cyclic, but it is preferably linear or branched and further preferably linear. The carbon atom number is 1 to 16, preferably 1 to 12, more preferably 1 to 6 and further preferably 1 to 4. Specific groups thereof include the groups where the oxygen atom is replaced by a sulfur atom. As an example, 2-coumaranone can be read into 1,2-dihydrothionaphthen-2-one and methoxy can be read into methylthio. Specifically, methylthio, ethylthio, propylthio, butylthio, amylthio, hexylthio, heptylthio, octylthio, nonylthio, decylthio, undecylthio, dodecylthio, tridecylthio, tetradecylthio, pentadecylthio or hexadecylthio is cited.

When the above Y is an alkylsulfonyl group having no substituent, “alkyl” of said alkylsulfonyl group may be any of linear, branched and cyclic, but it is preferably linear or branched and further preferably linear. The carbon atom number is 1 to 16, preferably 1 to 12, more preferably 1 to 6 and further preferably 1 to 4.

Specific examples of the alkylsulfonyl group include methylsulfonyl, ethylsulfonyl, propylsulfonyl, butylsulfonyl, pentylsulfonyl, hexylsulfonyl, octylsulfonyl, nonylsulfonyl, decylsulfonyl, undecylsulfonyl, dodecylsulfonyl, tridecylsulfonyl, tetradecylsulfonyl, pentadecylsulfonyl, hexadecylsulfonyl and the like.

When the above Y is a group selected from the group consisting of an aryloxy group, an arylthio group and an arylsulfonyl group, which have no substituent, the term “aryl” in said group means an aryl group having 6 to 14, preferably 6 to 12 and more preferably 6 to 10 carbon atoms

Specific examples of said aryl group include phenyl, naphthyl, anthracenyl, terphenyl and the like, and it is preferably phenyl or naphthyl and more preferably phenyl.

When the above Y is a group selected from the group consisting of a heteroaryloxy group, a heteroarylthio group and a heteroarylsulfonyl group which have no substituent, the term “heteroaryl” in said group means a heteroaryl group having 3 to 9, preferably 3 to 8 and more preferably 4 to 5 carbon atoms, which comprises 1 to 2 of each of a nitrogen atom, an oxygen atom or a sulfur atom, independently as a ring-constituting atom.

Specific examples of the heteroaryl group include ones containing a nitrogen atom, such as pyrazine, pyrimidine, pyridazine, pyridine, benzimidazole and quinoline; ones containing an oxygen atom, such as furan and benzofuran; ones containing a sulfur atom, such as thiophene and benzothiophene; and ones containing two or more ring-constituting hetero atoms other than a carbon atom, such as imidazole, thiazole, oxazole, benzimidazole, benzothiazole, benzisothiazole, benzoxazole and benzisoxazole. Said hetero aryl group is preferably monocyclic, more preferably it is monocyclic and contains a nitrogen atom, and further preferably it is, in addition to this, a 6-membered ring.

The above Y is more preferably an aryloxy group, an arylthio group or an arylsulfonyl group than a heteroaryloxy group, a heteroarylthio group or a heteroarylsulfonyl group.

When the above Y is a group selected from the group consisting of an alkoxy group, an alkylthio group and an alkylsulfonyl group which have a substituent, the substituent in these groups (hereinafter, referred to as substituent in the alkoxy group and the like) includes an aryl group, a heteroaryl group, an alkoxy group, an alkylsulfonyl group, an alkylthio group, an arylamino group, a diarylamino group, a heteroarylamino group, a diheteroarylamino group, an alkylamino group, a dialkylamino group, sulfo, carboxy, phosphono, sulfamoyl, carbamoyl, a hydroxy group, amino, acetylamino, ureide, a nitro, cyano or/and a halogen atom.

When the substituent in the above alkoxy group and the like is an aryl group or a heteroaryl group, said aryl or heteroaryl group has the same meaning as “aryl” or “heteroaryl” respectively described above in the case that “Y is a group selected from the group consisting of an aryloxy group, an arylthio group and an arylsulfonyl group, which have no substituent” or in the case that “Y is a group selected from the group consisting of a heteroaryloxy group, a heteroarylthio group or a heteroarylsulfonyl group, which have no substituent”.

In addition, when the substituent in the above alkoxy group and the like is an arylamino group, a diarylamino group, a heteroarylamino group or/and a diheteroarylamino group, the term “aryl” or “heteroaryl” in said substituent respectively has the same meaning as “aryl” or “heteroaryl” described above in the case that “the substituent in the above alkoxy group and the like is an aryl group or a heteroaryl group”.

The substituent in the above alkoxy group and the like is an alkoxy group, an alkylsulfonyl group or an alkylthio group, they have the same meanings as the groups respectively described in the case that “Y is an alkoxy group having no substituent”, “Y is an alkylsulfonyl group having no substituent” and “Y is an alkylthio group having no substituent”.

In addition, when the substituent in the above alkoxy group and the like is an alkylamino group or a dialkylamino group, the term “alkyl” in these substituents has the same meaning as “alkyl” in the above case that “Y is an alkylsulfonyl group having no substituent”.

When the substituent in the above alkoxy group and the like is a halogen atom, specific examples thereof include a fluorine atom, a chlorine atom, a bromine atom, an iodine atom and the like, a fluorine atom and a chlorine atom are preferable, and a chlorine atom is more preferable.

When the above Y is a group selected from the group consisting of an aryloxy group, an arylthio group, an arylsulfonyl group, a heteroaryloxy group, a heteroarylthio group and a heteroarylsulfonyl group which have a substituent, said substituent (hereinafter, also referred to as substituent in the aryloxy and the like) includes an alkyl group, alkoxy group, an alkylsulfonyl group, an alkylthio group, an arylamino group, a diarylamino group, a heteroarylamino group, a diheteroarylamino group, an alkylamino group, a dialkylamino group, sulfo, carboxy, phosphono, sulfamoyl, carbamoyl, a hydroxy group, amino, acetylamino, ureide, nitro, cyano or/and a halogen atom.

When the substituent in the above aryloxy and the like is an alkoxy group, an alkylsulfonyl group, an alkylthio group, an arylamino group, a diarylamino group, a heteroarylamino group, a diheteroarylamino group, an alkylamino group, a dialkylamino group and a halogen atom, the terms “alkyl”, “aryl” and “heteroaryl” in these groups have the same meanings respectively as those described for each group where the above Y has no substituent or those described for the substituent in each group of Y.

When the substituent in the above aryloxy and the like is an alkyl group, said alkyl group may be any of linear, branched or cyclic, but it is preferably linear or branched and more preferably linear. The carbon atom number is 1 to 16, preferably 1 to 12, more preferably 1 to 6 and further preferably 1 to 4.

Specific examples of the alkyl group include methyl, ethyl, propyl, butyl, pentyl, hexyl, octyl, nonyl, decyl, undecyl, dodecyl, tridecyl, tetradecyl, pentadecyl, hexadecyl and the like.

As the above Y, a hydrogen atom; nitro; carboxy; a group selected from the group consisting of an alkoxy group, an alkylthio group and an alkylsulfonyl group, which may be substituted; and a group selected from the group consisting of an aryloxy group, an arylthio group, an arylsulfonyl group and an amino group, which may be substituted are preferable, and a hydrogen atom or carboxy is more preferable. As Y, the most preferable is a hydrogen atom.

When the above Y has a substituent, said substituent may be one or more kinds selected from the above group. The number of the substituents is 1 to 4, preferably 1 to 3, more preferably 1 to 2, and particularly preferably 1.

When the above Y has one substituent, said substituent is preferably sulfo, carboxy, phosphono or a hydroxy group, more preferably sulfo, carboxy or a hydroxy group and further preferably sulfo or carboxy.

When the above Y has two or more kinds of substituents, one of them is advisably a group selected from sulfo, carboxy, phosphono or a hydroxy group; more preferably sulfo, carboxy or a hydroxy group; further preferably sulfo or carboxy.

The above L is from 2 to 8. As the number of L is larger, the solubility tends to be improved but the water fastness tends to be decreased, and therefore, the number of L can be appropriately controlled in view of the solubility and the water fastness. L is usually 2 to 8, preferably 3 to 7 and more preferably 4 to 6. When L is from 4 to 5, moderate water-solubility and better water fastness can be obtained, and when L is from 5 to 6, moderate water fastness and better water-solubility can be obtained. The most preferable is from 4 to 5.

With regard to the above M, X, Y and the substituents of Y and to L, a combination of the substituents and L listed as preferable is more preferable, and a combination of the substituents and L listed as more preferable is further preferable. In addition, a combination of the substituents and L listed as further preferable is the same.

Specific examples thereof can include a combination where M is a copper atom and Y is a hydrogen atom or a carboxy group, and more preferably a combination where M is a copper atom and Y is a hydrogen atom. In addition, a further preferable combination thereof can include a combination of these M and Y, further combined with the case that L is from 3 to 7 and more preferably from 4 to 6.

Further, a combination where each of these combinations is further combined with the case that X is a sulfonyl group can be cited as a further preferable combination.

Furthermore, a combination where each of the above combinations is further combined with the case that the degree of substitution for the pyridine ring described later is 0 to 2, more preferably 0 to 1.5, further preferably 0 to 1.25 and most preferably 0 (where all of the rings A to D are benzene rings) can be cited as a further preferable combination.

Meanwhile, as the coloring matter of the above formula (1), one of preferable coloring matters is the coloring matter represented by the above formula (111). In the formula (111), M represents a hydrogen atom, a metal atom, a metal oxide, a metal hydroxide or a metal halide,

X depicts a carbonyl group or a sulfonyl group,
Y represents a hydrogen atom or a carboxy group, and preferably a hydrogen atom,
L is from 2 to 8,
each of Z₁ to Z₈ independently represents a nitrogen atom or a carbon atom; among four combinations of Z₁ and Z₂, Z₃ and Z₄, Z₅ and Z₆ and Z₇ and Z₈, at least one is a combination of carbon atoms and also the rest three do not include a combination of nitrogen atoms. That is, in each of the above four combinations, either is a carbon atom and the other represents a carbon atom or a nitrogen atom, and at least one of the others represents a carbon atom.

In the above formula (111), M, X, Y and L are the same as in the above formula (1), including combinations of preferable ones and preferable ones, and the like.

Among the four combinations of Z₁ and Z₂, Z₃ and Z₄, Z₅ and Z₆ and Z₇ and Z₈, the number of the combinations comprising a nitrogen atom is usually in the range of preferably 0 to 2, more preferably 0 to 1.5 and further preferably 0 to 1.25 as an average value. The rest combinations comprising no nitrogen atom are a combination of carbon atoms. It is the most preferable in terms of hue of cyan coloring matter that all of the above four combinations are a combination of carbon atoms.

One of further preferable coloring matters as the coloring matter of the above formula (1) is the coloring matter of the above formula (2).

In the formula (2), L is from 2 to 8, preferably from 3 to 7 and more preferably from 4 to 6,

each of Z₁ to Z₈ independently represents a nitrogen atom or a carbon atom, at least one among the combinations of Z₁ and Z₂, Z₃ and Z₄, Z₅ and Z₆, and, Z₇ and Z₈ is a combination of carbon atoms, and the rest 3 combinations do not include a combination of nitrogen atoms. That is, in each of the above four combinations, either is a carbon atom and the other represents a carbon atom or a nitrogen atom, and at least one of the others represents a carbon atom.

In the above formula (2), L may be the same as in the above formula (1) and Z₁ to Z₈ is the same as in the above formula (111), respectively including the preferable ones.

Specific, preferable combinations include a combination where L is from 4 to 6, the substitution ratio of a nitrogen atom in the above four combinations is from 0 to 2, more preferably from 0 to 1.5 and further preferably from 0 to 1.25, and the most preferably all of the above four combinations are a combination of carbon atoms.

It is possible that the compound of the above formula (1) forms a salt using sulfo, carboxy, phosphono and the like in a molecule thereof. The salt of the compound of the formula (1) can include salts of the compound of the formula (1) with a base selected from the group consisting of an inorganic metal, ammonium and an organic base.

The inorganic metal includes alkali metals and alkali earth metals. Examples of the alkali metal include lithium, sodium, potassium and the like. The alkali earth metal includes, for example, calcium, magnesium and the like.

The organic base particularly includes organic amines, for example, lower alkyl amines having 1 to 3 carbon atom such as methylamine and ethylamine, and mono-, di- or tri(lower alkanol) amines (having 1 to 4 carbon atoms) such as monoethanolamine, diethanolamine, triethanolamine, monoisopropanolamine, diisopropanolamine and triisopropanolamine.

Preferable salts of the compound of the formula (1) include salts with an alkali metal such as sodium, potassium and lithium (alkali metal salt), salts with monoethanolamine, diethanolamine, triethanolamine, monoisopropanolamine, diisopropanolamine, triisopropanolamine and the like (an onium salt of mono-, di- or tri(lower alkanol)amine (having 1 to 4 carbon atoms), and salts with ammonia (ammonium salt).

In this connection, the description for these salts is the same as in the formula (2) and the formula (111).

Specific examples of the rings A to D, X and Y and the number of L in the porphyrazine coloring matter represented by the above formula (1) in the present invention are shown in the table 1.

The following examples show typical compounds to specifically explain the coloring matter of the present invention and the present invention is not limited the following examples. In this connection, the functional groups such as sulfonic acid are depicted in free acid form.

In addition, positional isomers and the like of the nitrogen atom are exist in the rings A to D as described later and therefore a mixture of the isomers is obtained in synthesis of the coloring matter. It is difficult to isolate these isomers and to identify the isomers by analysis. For this reason, a mixture thereof is usually used as it is, and however one structural formula is described for the indication of structural formula without distinguish these isomers, as the above for convenience, because even though the coloring matter is a mixture of the isomers, it particularly causes no problem on the present invention.

TABLE 1

| No. | A | B | C | D | X | Y | 1 |
|---|---|---|---|---|---|---|---|
| 1 | Benzo | Benzo | Benzo | Benzo | —SO2— | —H | 4~5 |
| 2 | 2,3-Pyrido | Benzo | Benzo | Benzo | —SO2— | —H | 4~5 |
| 3 | 2,3-Pyrido | Benzo | 2,3-Pyrido | Benzo | —SO2— | —H | 3~4 |
| 4 | 2,3-Pyrido | 2,3-Pyrido | Benzo | Benzo | —SO2— | —H | 3~4 |
| 5 | 2,3-Pyrido | 2,3-Pyrido | 2,3-Pyrido | Benzo | —SO2— | —H | 2~3 |
| 6 | Benzo | Benzo | Benzo | Benzo | —CO— | —H | 3~4 |
| 7 | Benzo | Benzo | Benzo | Benzo | —CO— | —H | 7~8 |
| 8 | Benzo | Benzo | Benzo | Benzo | —CO— | —NO2 | 7~8 |
| 9 | Benzo | Benzo | Benzo | Benzo | —CO— | —O(CH2)2COOH | 3~4 |
| 10 | Benzo | Benzo | Benzo | Benzo | —CO— | —S(CH2)2COOH | 3~4 |
| 11 | Benzo | Benzo | Benzo | Benzo | —CO— | —SO2(CH2)2COOH | 3-4 |
| 12 | Benzo | Benzo | Benzo | Benzo | —CO— | —S(CH2)5CH3 | 5~6 |
| 13 | Benzo | Benzo | Benzo | Benzo | —CO— | —SO2(CH2)5CH3 | 5~6 |
| 14 | Benzo | Benzo | Benzo | Benzo | —CO— | —SPh | 5~6 |
| 15 | Benzo | Benzo | Benzo | Benzo | —CO— | —SO2Ph | 5~6 |
| 16 | 2,3-Pyrido | Benzo | Benzo | Benzo | —CO— | —O(CH2)2COOH | 3~4 |
| 17 | Benzo | 2,3-Pyrido | Benzo | Benzo | —CO— | —S(CH2)2COOH | 3~4 |
| 18 | Benzo | Benzo | 2,3-Pyrido | Benzo | —CO— | —SO2(CH2)2COOH | 3~4 |
| 19 | Benzo | Benzo | Benzo | 2,3-Pyrido | —CO— | —S(CH2)5CH3 | 4~5 |
| 20 | 2,3-Pyrido | 2,3-Pyrido | Benzo | Benzo | —CO— | —SO2(CH2)5CH3 | 3~4 |
| 21 | Benzo | 2,3-Pyrido | 2,3-Pyrido | Benzo | —CO— | —SPh | 3~4 |
| 22 | 2,3-Pyrido | Benzo | Benzo | Benzo | —CO— | —SO2Ph | 3~4 |
| 23 | Benzo | Benzo | Benzo | Benzo | —CO— | —OPh | 3~4 |
| 24 | Benzo | Benzo | Benzo | Benzo | —CO— | —NH(CH2)2COOH | 2~3 |
| 25 | Benzo | Benzo | Benzo | Benzo | —CO— | —N(CH2COOH)2 | 2~3 |
| 26 | Benzo | Benzo | Benzo | Benzo | —CO— | —N(CH2CH2CH2CH3)2 | 2~3 |
| 27 | Benzo | Benzo | Benzo | Benzo | —SO2— | —H | 5~6 |
| 28 | Benzo | Benzo | Benzo | Benzo | —SO2— | —H | 3~4 |
| 29 | Benzo | 2,3-Pyrido | Benzo | 2,3-Pyrido | —SO2— | —H | 4~5 |
| 30 | 2,3-Pyrido | 2,3-Pyrido | Benzo | Benzo | —SO2— | —H | 4~5 |

Next, the method for producing azaphthalocyanine (which is usually a group where 1 to 3 ring out of 4 benzo (benzene) rings of a group referred to as phthalocyanine is replaced by a pyridine ring) will be explained.

The copper porphyrazine coloring matter represented by the formula (6) described later is obtained by reaction of a pyridinedicarboxylic acid derivative with a phthalic acid derivative in the presence of, for example, a catalyst and a copper compound. It is possible to control the numbers of pyridine ring and benzene ring which are introduced as the rings A to D by changing the molar ratio in the reaction of a pyridinedicarboxylic acid derivative and a phthalic acid derivative.

For example, when 1 to 3 of four 6-membered aromatic rings of A to D in the present invention is a pyridine ring and the rest are benzene rings, an intended compound can be obtained by using the pyridinedicarboxylic acid derivative in the ratio range of 0.0 to 0.75 mol and the phthalic acid derivative in the ratio range of 0.25 to 1.0 mol so that the total of the both is 1 mol, according to the content ratio.

For example, when the number of pyridine rings is 1 and the number of benzene rings is 3, the pyridinedicarboxylic acid derivative can be used in the ratio of 0.25 mol and the phthalic acid derivative can be used in the ratio of 0.75 mol.

The pyridinedicarboxylic acid derivative includes pyridinedicarboxylic acid derivatives (also including pyridinedicarboxylic acid) having a carboxy group or a reactive group introduced therefrom (an acid amide group, an imide group, an acid anhydride group, a carbonitrile group and the like), respectively in two adjacent positions. Specific examples thereof include dicarboxylic acid compounds such as quinolinic acid and 3,4-pyridinedicarboxylic acid, acid anhydrides such as quinolinic anhydride and 3,4-pyridinedicarboxylic acid anhydride, amide compounds such as pyridine-2,3-dicarboxamide, dicarboxylic acid monoamide compounds such as pyridine-2,3-dicarboxylic acid monoamide, acid imide compounds such as quinolinic acid imide, and dicarbonitrile compounds such as pyridine-2,3-dicarbonitrile. Among them, pyridine-2,3-dicarboxylic acid or derivatives having a reactive group on the same substitution positions thereas are preferable. In addition, the phthalic acid derivative includes phthalic acid, phthalic anhydride, phthalamide, phthalamic acid, phthalimide, phthalonitrile, 1,3-diiminoisoindoline, 2-cyanobenzamide and the like.

The method for synthesizing the copper porphyrazine represented by the following formula (6) generally includes two methods called nitrile method and Wyler method, which have different reaction conditions.

The nitrile method is a method where a dicarbonitrile compound such as pyridine-2,3-dicarbonitrile and phthalonitrile is used as a raw material for synthesis.

On the other hand, Wyler method uses a dicarboxylic acid compound such as phthalic acid, quinolinic acid and 3,4-pyridinedicarboxylic acid, an acid anhydride compound such as phthalic anhydride, quinolinic anhydride and 3,4-pyridinedicarboxylic acid anhydride, a dicarboxamide compound such as phthalamide and pyridine-2,3-dicarboxamide, a dicarboxylic acid monoamide compound such as phthalamic acid and pyridine-2,3-dicarboxylic acid monoamide, and an acid imide compound such as phthalimide and quinolinic acid imide, as a raw material. In addition, Wyler method requires addition of urea and the use amount of urea is 5 to 100 times mol relative to the total 1 mol of the pyridinedicarboxylic acid derivative and the phthalic acid derivative.

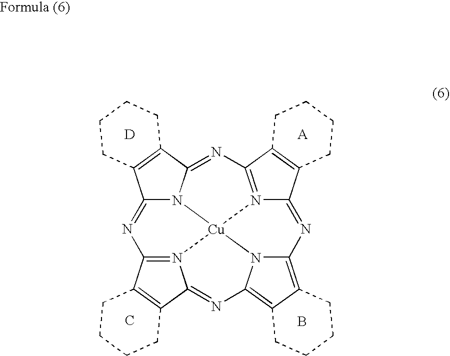

Wherein, the rings A to D have the same meanings as those in the formula (1).

The reaction is carried out in the presence of a solvent, and as the solvent in the nitrile method, an organic solvent having a boiling point of 100° C. or more and more preferably 130° C. or more is used. Said organic solvent includes, for example, n-amyl alcohol, n-hexanol, cyclohexanol, 2-methyl-1-pentanol, 1-heptanol, 1-octanol, 2-ethylhexanol, N,N-dimethylaminoethanol, benzyl alcohol, ethylene glycol, propylene glycol, trichlorobenzene, chloronaphthalene, nitrobenzene, quinoline, sulfolane, urea and the like.

On the other hand, as the solvent in Wyler method, an aprotic organic solvent having a boiling point of 150° C. or more and more preferably 180° C. or more is used. Examples thereof include trichlorobenzene, chloronaphthalene, nitrobenzene, quinoline, sulfolane, urea and the like.

The use amount of the solvents is 1 to 100 mass times of the total of the pyridinedicarboxylic acid derivative and the phthalic acid derivative.

As the catalyst, the followings can be used.

In the nitrile method, examples thereof include amines such as quinoline, 1,8-diazabicyclo[5,4,0]-7-undecene, tributylamine, ammonia, and N,N-dimethylaminoethanol and alkali metal alcoholates such as sodium ethoxide and sodium methoxide.

On the other hand, examples thereof in Wyler method include ammonium molybdate and boric acid. The addition amount of the catalyst is 0.001 to 1 molar time relative to the total 1 mol of the pyridinedicarboxylic acid derivative and the phthalic acid derivative.

The copper compound includes metal copper, and halide, carboxylate, sulfate, nitrate, acetylacetonate, complexes of copper, and the like. Examples thereof include copper chloride, copper bromide, copper acetate, copper acetylacetonate and the like.

When porphyrazine having a central metal other than copper is desirably synthesized, a corresponding metal salt can be used or exchange reaction of a central metal can be carried out according to a conventional method after a porphyrazine ring is synthesized.

The use amount of the copper compound is 0.15 to 0.35 molar times relative to the total 1 mol of the nitrogen-containing heteroaromatic ring dicarboxylic acid derivative and the phthalic acid derivative.

In the nitrile method, the reaction temperature is usually 100 to 200° C. and preferably 130 to 170° C.

On the other hand, the reaction temperature in Wyler method is 150 to 300° C. and preferably 170 to 220° C.

The reaction time varies depending on the reaction conditions, but it is usually 1 to 40 hours. After completion of the reaction, the intended product is separated by filtration, washed and dried to obtain a copper porphyrazine.

Taking a compound where two of the rings A to D in the above formula (6) are pyridine rings and the rest two are benzene rings, i.e. copper dibenzobis(2,3-pyrido)porphyrazine for example, the method for synthesizing will be more specifically explained.

For example, by reacting quinolinic acid (0.5 mol), phthalic anhydride (0.5 mol), copper (II) chloride (0.25 mol), ammonium phosphomolybdate (0.004 mol) and urea (6 mol) at 200° C. for 5 hours in a sulfolane solvent, a copper dibenzobis(2,3-pyrido)porphyrazine where two of the rings A to D are pyridine rings and the rest two are benzene rings in the above formula (6) is obtained. The reactivity varies depending on the kind and the use amount of the quinolinic acid, the phthalic anhydride, the metal compound, the solvent, the catalyst and the like, and the method is not limited thereto.

In addition, when synthesis is carried out according to the above synthesis method, the main component is copper dibenzobis(2,3-pyrido)porphyrazine, where five kinds of its isomers {the following formulas (7-A) to (7-E)} in which the position of the pyridine ring and the position of the nitrogen atom of the pyridine ring are different are produced. At the same time, copper tribenzo(2,3-pyrido)porphyrazine represented by the above formula (6) where one of the rings A to D is a pyridine ring and the rest three are benzene rings (the formula (8) described later) and copper benzo tris(2,3-pyrido)porphyrazine represented by the above formula (6) where three of the rings A to D are pyridine rings and the rest one is a benzene ring are by-produced, and in these compounds, positional isomers of the nitrogen atom of the pyridine ring {the following formulas (9-A) to (9-D)} exist, whereby the product is a complicated mixture. In addition, copper tetrakis(2,3-pyrido)porphyrazine and copper phthalocyanine (copper tetrabenzoporphyrazine) are also produced even in a small amount. Usually, it is difficult to isolate only an intended product from these mixtures, and in most cases, the mixture is used as it is, as copper dibenzobis(2,3-pyrido)porphyrazine where two are pyridine rings and the rest two are benzene rings as an average value.

In accordance with the above method for synthesizing copper dibenzobis(2,3-pyrido)porphyrazine, a compound where one is a pyridine ring and the rest three are benzene rings, and the like can be obtained. In this case, the use ratio of the pyridinedicarboxylic acid derivative and the phthalic acid derivative can be changed according to the ratio of the pyridine ring and the benzene ring of an intended compound for synthesis.

In addition, for a compound where all of the rings A to D are benzene rings, reaction can be carried out not using a pyridinedicarboxylic acid derivative, but using only a phthalic acid derivative, as a material compound in the above synthesis method.

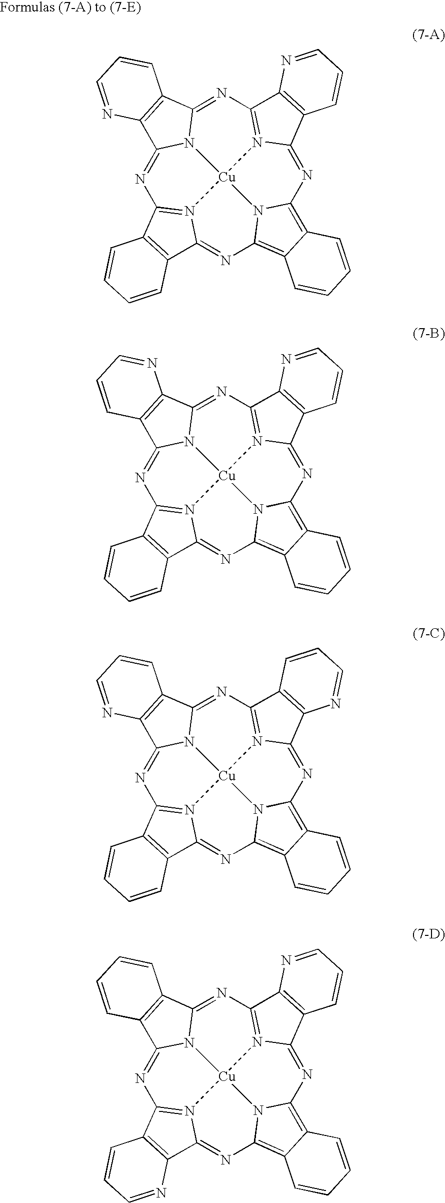

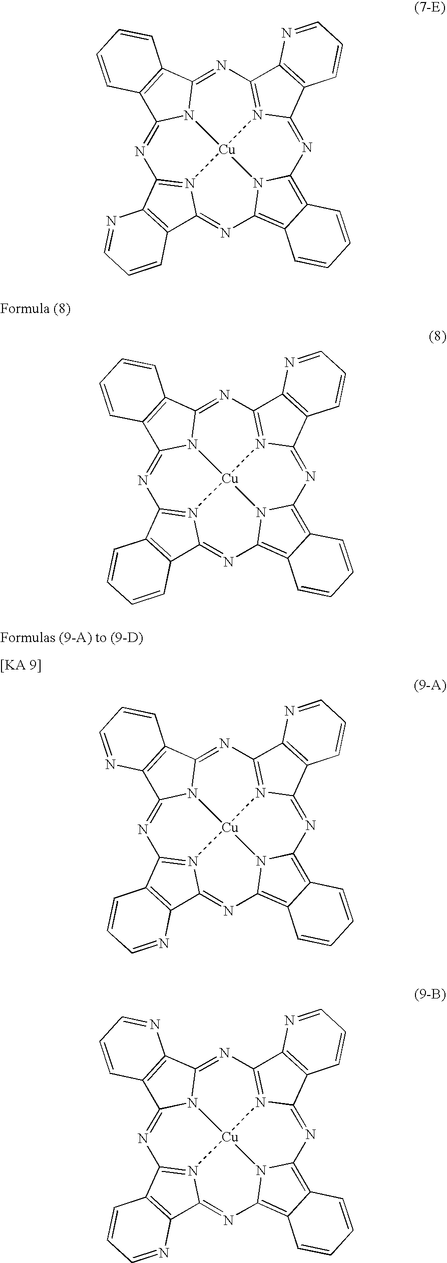

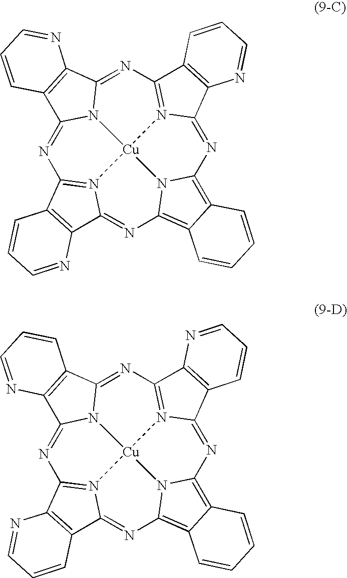

Next, the method for producing the coloring matter of the formula (1) of the present invention will be explained.

In this connection, all of the symbols such as the rings A to D, M, X, Y, L and the like in the following formulas have the same meanings as in the formula (1).

The coloring matter represented by the formula (1) can be obtained by hydrolyzing a compound represented by the following formula (3) with a basic aqueous solution.

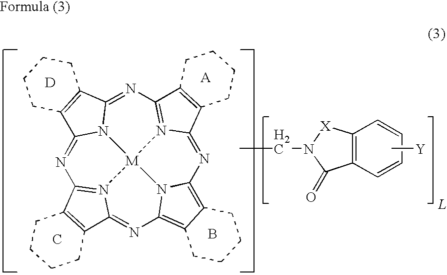

For the compound of the above formula (3), for example, a compound represented by the above formula (6) and a compound represented by the following formula (4) can be subjected to dehydration condensation or the three of a compound represented by the formula (6), a compound represented by the following formula (5) and paraformaldehyde can be subjected to dehydration condensation, according to the method described in Patent JP-3413223 or based thereon.

The dehydration condensation agent to be used in said condensation includes sulfuric acid, fuming sulfuric acid, polyphosphoric acid, acetic anhydride, diphosphorus pentaoxide and the like, but not limited thereto. In addition, one or more kinds of the above dehydration condensation agents can be also used in combination.

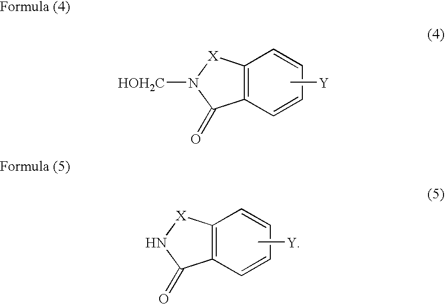

When the above three are subjected to dehydration condensation reaction, sulfuric acid, fuming sulfuric acid, polyphosphoric acid or the like is usually used as a condensation agent. In addition, when sulfuric acid or fuming sulfuric acid is used, it is also possible to introduce a sulfo group on one or more benzene rings existing in a compound represented by the above formula (3).

Usually, the dehydration condensation agent is also used as a solvent, and the use amount thereof is 5 to 20 times weight and preferably 8 to 15 times weight of the compound represented by the above formula (6), by weight ratio.

The reaction conditions such as reaction temperature and reaction time vary depending on the number of phthalimide methyl groups to be introduced, the kind of the dehydration condensation agent, and the like.

The reaction temperature is usually 50 to 160° C. and the reaction time is usually 1 to 20 hours.

The use amount of the compound represented by the formula (4) varies depending on the number of phthalimide methyl groups to be introduced and can be usually changed according to the desired number to be introduced. For example, the use amount thereof is 1 to 8 molar times and preferably 2 to 8 molar times relative to the compound of the above formula (6). It is also possible to use a compound represented by the formula (5) and paraformaldehyde instead of the compound represented by the formula (4), and in this case, the compound represented by the formula (5) may be used in the same amount as the compound represented by the formula (4). Paraformaldehyde is usually used in a molar quantity of 1 to 2 times of the compound represented by (5).

In addition, the compound represented by the formula (4) can be otherwise synthesized by reaction of a compound represented by the formula (5) with a aqueous formalin solution.

By hydrolyzation of the resulting compound represented by the formula (3), the coloring matter represented by the above formula (1) of the present invention can be obtained. The base to be used in said hydrolyzation includes alkali metal hydroxides, for example, sodium hydroxide, potassium hydroxide and the like. The base to be used is not limited thereto.

The hydrolyzation reaction is carried out in a basic aqueous solution which is obtained by addition of the above base. The base concentration of said basic aqueous solution is 0.5 to 10% by mass and the use amount thereof is 3 to 20 times weight of phthalimide methylated phthalocyanine. The reaction temperature is usually 10 to 90° C. and more preferably 15 to 70° C.

The thus obtained coloring matter of the present invention can be separated by aciding out or salting out. The aciding out is carried out by, for example, adjusting the pH of the reaction liquid to 1 to 3 with an acid such as hydrochloric acid and sulfuric acid and by precipitating the intended compound. The temperature at this time is not particularly limited, but usually 20 to 80° C. and preferably 20 to 60° C. The salting out is carried out by, for example, adjusting the reaction liquid in the acidic to alkaline range of pH and preferably in the range of pH 1 to 11, and by addition of a salt such as sodium chloride to precipitate the intended compound. The temperature in salting out is not particularly limited, but it is preferable that after heating to usually 20 to 80° C. and preferably 40 to 70° C., sodium chloride is added for salting out.

The coloring matter of the present invention is suitable for dyeing of natural and synthetic textiles or textile blends, production of inks for writing and of ink compositions for inkjet recording, and the like.

The reaction liquid containing the coloring matter of the above formula (1) of the present invention can be also used directly for production of the ink composition of the present invention. In addition, it is also possible that said coloring matter is isolated from the reaction liquid by, for example, such a method as spray-drying the reaction liquid and the like, and then, the obtained coloring matter is processed into an ink composition. The ink composition of the present invention contains the coloring matter represented by the above formula (1) in an amount of usually 0.1 to 20% by mass, more preferably 1 to 10% by mass and further preferably 2 to 8% by mass in an aqueous medium.

The ink composition of the present invention can be obtained by, usually, dissolving the coloring matter of the above formula (1) in an aqueous medium such as water/or a mixed solution of water and a water-soluble organic solvent (a water-miscible organic solvent) and, according to necessity, by addition of an ink preparation agent. When this ink composition is used for an ink for inkjet printer, it is preferable to use the ink composition containing less content of inorganic substances such as metal cation chloride, for example, sodium chloride, sulfate (sodium sulfate as typical) and the like, which are contained as impurities. In this case, the total content of, for example, sodium chloride and sodium sulfate is preferably 1% by mass or less in the total mass of the coloring matter contained in an ink. In order to produce the coloring matter containing less inorganic impurities, desalting treatment can be carried out by, for example, a known method per se using a reverse osmosis membrane or a method where a dried form or a wet cake of the coloring matter of the present invention or a salt thereof is stirred in a mixed solvent of alcohol such as methanol and water followed by purification-suspension and the resulting solid is separated by filtration and dried, or otherwise.

The ink composition of the present invention contains the coloring matter of the above formula (1) and water as a medium and, according to necessity, may contain a water-soluble organic solvent within the range not impairing the effects of the present invention. The water-soluble organic solvent serves as a dye dissolving agent, a drying preventive agent (wetting agent), a viscosity modifier, a penetration enhancer, a surface tension modifier, an antifoaming agent and the like. The other ink preparation agents includes, for example, known additives such as antiseptic and fungicide, a pH adjuster, a chelating agent, a rust preventive agent, an ultraviolet absorbing agent, a viscosity modifier, a dye dissolving agent, an antifading agent, an emulsion stabilizer, a surface tension modifier, an antifoaming agent, a dispersing agent and a dispersion stabilizer. The content of the water-soluble organic solvent is 0 to 60% by mass and preferably 10 to 50% by mass relative to the whole ink, and the other ink preparation agents are advisably used in an amount of 0 to 20% by mass and preferably 0 to 15% by mass relative to the whole ink. The rest other than the above is water.

The water-soluble organic solvent which can be used in the present invention includes, for example, C1 to C4 alkanols such as methanol, ethanol, n-propanol, isopropanol, n-butanol, isobutanol, secondary butanol and tertiary butanol; amides such as N,N-dimethylformamide or N,N-dimethylacetoamide; heterocyclic ketones such as 2-pyrrolidone, N-methyl-2-pyrrolidone, hydroxyethyl-2-pyrrolidone, 1,3-dimethylimidazolidin-2-one or 1,3-dimethylhexahydropyrimid-2-one; aliphatic ketones or aliphatic ketoalcohols such as acetone, methyl ethyl ketone and 2-methyl-2-hydroxypentan-4-one; cyclic ethers such as tetrahydrofuran and dioxane; mono-, oligo- or polyalkylene glycols or thioglycols having a (C2 to C6) alkylene unit such as ethylene glycol, 1,2- or 1,3-propylene glycol, 1,2- or 1,4-butylene glycol, 1,6-hexylene glycol, diethylene glycol, triethylene glycol, tetraethylene glycol, dipropylene glycol, polyethylene glycol, polypropylene glycol and thiodiglycol; polyols (preferably, triol) such as glycerine and hexane-1,2,6-triol; (C1 to C4) monoalkyl ethers of polyhydric alcohols such as ethylene glycol monomethyl ether, ethylene glycol monoethyl ether, diethylene glycol monomethyl ether, diethylene glycol monoethyl ether, diethylene glycol monobutyl ether (butyl carbitol), triethylene glycol monomethyl ether, triethylene glycol monoethyl ether; gamma-butyrolactone or dimethylsulfoxide; and the like.

As the above water-soluble organic solvent, preferable are isopropanol, glycerine, mono-, di- or triethylene glycol, dipropylene glycol, 2-pyrrolidone, N-methyl-2-pyrrolidone and butyl carbitol, and more preferable are isopropanol, glycerine, diethylene glycol, 2-pyrrolidone, N-methyl-2-pyrrolidone and butyl carbitol. These water-soluble organic solvents are used alone or as a mixture thereof.

The antiseptic and fungicide includes, for example, compounds such as organic sulfur-based, organic nitrogen sulfur-based, organic halogen-based, haloallyl sulfone-based, iodopropargyl-based, N-haloalkylthio-based, benzothiazole-based, nitrile-based, pyridine-based, 8-oxyquinoline-based, isothiazoline-based, dithiol-based, pyridineoxide-based, nitropropane-based, organic tin-based, phenol-based, quaternary ammonium salt-based, triazine-based, thiadiazine-based, anilide-based, adamantane-based, dithiocarbamate-based, brominated indanone-based, benzyl bromoacetate-based, inorganic salt-based and the like.

The organic halogen-based compound includes, for example, sodium pentachlorophenol, the pyridineoxide-based compound includes, for example, sodium 2-pyridinethiol-1-oxide, and the isothiazoline-based compound includes, for example, 1,2-benzisothiazolin-3-one, 2-n-octyl-4-isothiazolin-3-one, 5-chloro-2-methyl-4-isothiazolin-3-one, 5-chloro-2-methyl-4-isothiazolin-3-one magnesium chloride, 5-chloro-2-methyl-4-isothiazolin-3-one calcium chloride, 2-methyl-4-isothiazolin-3-one calcium chloride and the like.

In addition, the antiseptic and fungicide includes sodium acetate, sodium sorbate, sodium benzoate and the like. The other preferable specific examples of the antiseptic and fungicide includes, for example, Proxel GXL(S), Proxel XL-2(S) and the like which are trade names and manufactured by Avecia Corp.

As the pH adjuster, any substance can be used as long as it can control the pH of the ink in the range of 6.0 to 11.0 for the purpose of improving the storage stability of ink. For example, the pH adjuster includes alkanolamines such as diethanolamine and triethanolamine, alkali metal hydroxides such as lithium hydroxide, sodium hydroxide and potassium hydroxide, ammonium hydroxide, alkali metal carbonates such as lithium carbonate, sodium carbonate and potassium carbonate, or the like.

The chelating agent includes, for example, sodium ethylenediaminetetraacetate, sodium nitrilotriacetate, sodium hydroxyethylethylenediamine triacetate, sodium diethylenetriaminepentaacetate, sodium uracil diacetate and the like.

The rust preventive agent includes, for example, hydrogen sulfite salt, sodium thiosulfate, ammonium thioglycolate, diisopropylammonium nitrite, pentaerythritol tetranitrate, dicyclohexylammonium nitrite and the like.

As the ultraviolet absorbing agent, for example, a benzophenone-based compound, a benzotriazole-based compound, a cinnamic acid-based compound, a triazine-based compound, a stilbene-based compound, and also a compound (so-called fluorescent brightening agent) which absorbs ultraviolet rays and radiates fluorescence, as typified by benzoxazole-based compounds, can be used.

The viscosity modifier includes water-soluble polymer compounds in addition to the water-soluble organic solvent, for example, polyvinyl alcohols, cellulose derivatives, polyamines, polyimines and the like.

The dye dissolving agent includes, for example, urea, epsilon-caprolactam, ethylene carbonate and the like. It is preferable to use urea.

The antifading agent is used for the purpose of improving the storage stability of image. As the antifading agent, various organic-based and metal complex-based antifading agents can be used. The organic antifading agent includes hydroquinones, alkoxyphenols, dialkoxyphenols, phenols, anilines, amines, indanes, chromans, alkoxyanilines, heterocycles and the like, and the metal complex includes nickel complexes, zinc complexes and the like.

The surface tension modifier includes surfactants, for example, anionic surfactants, amphoteric surfactants, cationic surfactants, nonionic surfactants and the like.

The anionic surfactant includes alkylsulfocarboxylate, alpha-olefin sulfonate, polyoxyethylene alkyl ether acetate, N-acylamino acid and a salt thereof, N-acylmethyltaurine salt, alkylsulfate polyoxyalkyl ether sulfate, alkylsulfate polyoxyethylene alkyl ether phosphate, rosin acid soap, caster oil sulfate, lauryl alcohol sulfate, alkylphenol type phosphate ester, alkyl type phosphate ester, alkylallylsulfonate, diethyl sulfosuccinate, diethylhexyl sulfosuccinate, dioctyl sulfosuccinate and the like.

The cationic surfactant includes 2-vinylpyridine derivatives, poly(4-vinylpyridine) derivatives and the like.

The amphoteric surfactant includes lauryldimethylaminoacetic acid betaine, 2-alkyl-N-carboxymethyl-N-hydroxyethyl imidazolinium betaine, coconut oil fatty acid amide propyldimethylaminoacetic acid betaine, polyoctylpolyaminoethylglycine, and in addition, imidazoline derivatives and the like.

The nonionic surfactant includes surfactants of ether-based such as polyoxyethylene nonylphenyl ether, polyoxyethylene octylphenyl ether, polyoxyethylene dodecylphenyl ether, polyoxyethylene oleyl ether, polyoxyethylene lauryl ether, polyoxyethylene alkyl ether and the like; ester-based such as polyoxyethylene oleate ester, polyoxyethylene distearate ester, sorbitan laurate, sorbitan monostearate, sorbitan monooleate, sorbitan sesquioleate, polyoxyethylene monooleate, polyoxyethylene stearate; acetylene glycol (alcohol)-based such as 2,4,7,9-tetramethyl-5-decyne-4,7-diol, 3,6-dimethyl-4-octyne-3,6-diol, 3,5-dimethyl-1-hexyn-3-ol and the like (for example, Surfynol 104, 82 and 465, Olfine STG and the like, which are trade names and manufactured by Nissin Chemical Industry Co., Ltd.); and the like.

As the antifoaming agent, a highly oxidized oil-based, glycerin fatty acid ester-based, fluorine-based or silicone-based compound is used according to necessity.

These ink preparation agents are used alone or a mixture thereof. In addition, the surface tension of the ink of the present invention is usually 25 to 70 mN/m and more preferably 25 to 60 mN/m. Further, the viscosity of the ink of the present invention is adjusted preferably to 30 mPa·s or less and more preferably to 20 mPa·s or less.

In production of the ink composition of the present invention, the order of dissolving each agent such as additives is not particularly limited. As water to be used, water with less impurity such as ion-exchanged water or distilled water is preferable. In addition, microfiltration may be carried out, according to necessity, using a membrane filter or the like to remove foreign substances, and it is preferable to carry out microfiltration when the ink composition is used as an ink for inkjet printer. The pore size of a filter for microfiltration is usually 1 micron to 0.1 micron and preferably 0.8 microns to 0.2 microns.

The ink composition containing the coloring matter of the present invention is suitably used for impress printing, copying, marking, writing, drafting, stamping, or recording (printing), and particularly for inkjet recording and the like. In addition, the ink composition of the present invention hardly causes crystal precipitation in spite of the dry in the vicinity of the nozzle and clogging at the head in an inkjet printer. Further, when the ink composition of the present invention is used for inkjet recording, high quality cyan printed matters having good fastnesses to water, light, ozone and nitrogen oxide gas and to friction can be obtained, and particularly water fastness thereof on plain paper is extremely good.

Some inkjet printers comprise two kinds of inks, a high concentration ink and a low concentration ink, in one printer for the purpose of providing high resolution images. In that case, the coloring matter of the present invention is used to make a high concentration ink composition and a low concentration ink composition respectively, which may be used as an ink set. In addition, said coloring matter may be used for either of them. Further, the coloring matter of the present invention may be used in combination with a known cyan coloring matter. Furthermore, the coloring matter of the present invention can be used for color toning of another color, for example, black ink or for the purpose of preparing a green ink and a blue (or violet) ink by mixing with a yellow coloring matter and a magenta coloring matter.

The colored product of the present invention means a product colored with the coloring matter of the present invention. The quality of material for the colored product is not particularly limited and can be any, for example, communication sheets such as paper and film, fiber and cloth (such as cellulose, nylon and wool), leather, substrates for color filters, and the like as long as it can be colored, and thus the material is not limited thereto. The coloration includes, for example, printing methods such as dip dyeing, textile printing and screen printing, and a method by an inkjet printer, and the method by an inkjet printer is preferable.

The communication sheet is not particularly limited, and sheet subjected to surface treatment, specifically a sheet provided with an ink receiving layer on its substrate such as paper, synthetic paper and film can be used, not to mention plain paper. Here, the ink receiving layer is provided by, for example, a method where a cation polymer is impregnated or coated on the above substrate or a method where inorganic particles which can absorb the coloring matter in an ink, such as porous silica, aluminasol and special ceramics, are coated on the above substrate surface together with a hydrophilic polymer such as polyvinyl alcohol and polyvinylpyrrolidone. Sheet provided with such an ink receiving layer is usually called inkjet special paper, inkjet special film, glossy paper, glossy film or the like.

Plain paper refers to a paper particularly provided with no ink receiving layer and many various plain papers are commercially available for different uses. For an instance of commercially available plain paper, the plain paper for inkjet includes both sides-high quality plain paper (manufactured by Seiko-Epson Corporation), color plain paper (manufactured by Canon Inc.), Multipurpose Paper, All-in-One Printing Paper (manufactured by Hewlett Packard) and the like. In addition to these, paper for PPC which is not particularly limited to use for inkjet printing, or the like is also a plain paper.

The ink composition of the present invention is particularly excellent in water fastness on plain paper like the above and also excellent in the other fastnesses against light, ozone, humidity, friction and the like. It is also excellent in water fastness on inkjet special paper, special film, glossy paper, glossy film or the like which are provided with an ink receiving layer for inkjet printing, and also excellent in light fastness, gas fastness, moisture fastness and abrasion resistance on the communication sheets.

In order to record on a record-receiving material by the inkjet recording method of the present invention, for example, a container filled with the above ink composition (usually, ink container to be used for an inkjet printer) is placed in the predetermined position in an inkjet printer and recording can be performed on a record-receiving material by an ordinary method. In the inkjet recording method of the present invention, a yellow ink, a magenta ink, and according to necessity, a green ink, a blue (or violet) ink, a red ink, a black ink and the like can be used together with the ink composition of the present invention. In this case, each color ink is injected into each container and those containers are placed in the predetermined positions in an inkjet printer for use.

The inkjet printer includes, for example, printers using a piezo system where mechanical vibration is used, a bubble jet (registered trademark) system where bubbles generated by heating, and the like. The inkjet recording method of the present invention can be used by any system.

The ink composition of the present invention is vivid cyan, gives high color definition to images recorded on plain paper, inkjet special paper and glossy paper, and has a hue suitable for inkjet recording. In addition, it is characterized in that the fastnesses of the recorded images, particularly water fastness when recorded on plain paper are very high.

The ink composition of the present invention is free from precipitation and separation during storage. In addition, when the ink composition of the present invention is used for inkjet recording, crystal precipitation is more hardly caused by drying of the ink composition in vicinity of the nozzle and the injector (inkhead) is not clogged. The ink composition of the present invention is free from change in physical properties even when the ink is recirculated at a relatively long time interval using a continuous ink jet printer, or even in intermittent use by an on-demand printer.

### EXAMPLES

Hereinafter, the present invention will be more specifically explained with reference to the examples. In this connection, “part(s)” and “%” described herein are based on mass unless otherwise specifically noted.

In addition, the compounds of the above formula (1) synthesized in the examples are all a mixture containing isomers and the like as described above. Therefore, the chemical structural formulas of the principal components or the chemical structural formula of one of them are described unless otherwise specifically noted. In this connection, the yield contains said isomers and the like.

### Example 1

### Synthesis of the Coloring Matter Represented by the Following Formula (10)

The Coloring Matter of the Formula (1) Wherein Y is a Hydrogen Atom, X is Sulfonyl, L is from 5 to 6, and all of the Rings A to D are Benzene Rings

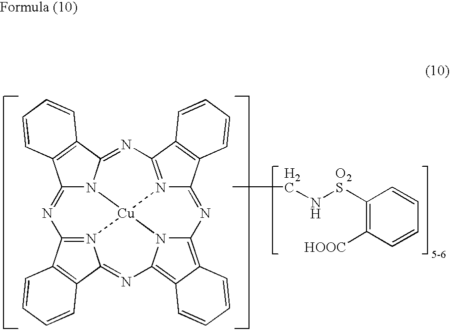

To 80.6 parts of polyphosphoric acid (116%), 5.76 parts of copper phthalocyanine, 20.15 parts of o-sulfobenzimide and 3.30 parts of paraformaldehyde were added, and the liquid temperature was raised to 140° C. After the reaction was carried out at 140 to 145° C. for 8 hours, the reaction liquid was cooled to 60° C. and 100 parts of water was added thereto to precipitate crystals. The crystals were separated by filtration and washed with 600 parts of water to obtain 60.6 parts of a wet cake. The obtained wet cake was added to a mixed liquid of 280 parts of water and 6.0 parts of sodium hydroxide, and the mixture was reacted at 20 to 25° C. for 6 hours. The reaction liquid was filtered, and 36% hydrochloric acid was added to the resulting filtrate to adjust the pH to 1 for precipitation of crystals. The crystals were separated by filtration, washed with 600 parts of water and dried to obtain 15.5 parts of a coloring matter represented by the above formula (10) as a blue powder.

### λmax: 678.0 nm, 645.0 nm (in DMF)

### Example 2

### Synthesis of the Coloring Matter of the Following Formula (11)

### The Coloring Matter of the Formula (1) Wherein Y is a Hydrogen Atom, X is Sulfonyl, L is from 4 to 5, and all of the Rings A to D are Benzene Rings

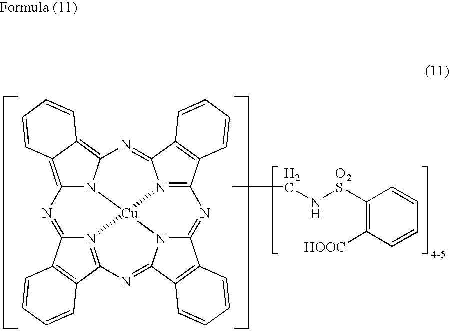

To 80.6 parts of polyphosphoric acid (116%), 5.76 parts of copper phthalocyanine, 16.12 parts of o-sulfobenzimide and 2.64 parts of paraformaldehyde were added, and then the liquid temperature was raised to 140° C. After the reaction was carried out at 140 to 145° C. for 8 hours, the reaction liquid was cooled to 60° C. and 100 parts of water was added thereto to precipitate crystals. The crystals were separated by filtration and washed with 600 parts of water to obtain 55.6 parts of a wet cake. The obtained wet cake was added to a mixed liquid of 280 parts of water and 4.8 parts of sodium hydroxide, and the mixture was reacted at 20 to 25° C. for 6 hours. The reaction liquid was filtered, and 36% hydrochloric acid was added to the resulting filtrate to adjust the pH of the filtrate to 1 for precipitation of crystals. The crystals were separated by filtration, washed with 600 parts of water and dried to obtain 14.5 parts of a coloring matter represented by the above formula (11) as a blue powder.

### λmax: 678.0 nm, 642.0 nm (in DMF)

### Example 3

### Synthesis of the Coloring Matter Represented by the Following Formula (12)

### The Coloring Matter of the Formula (1) Wherein Y is a Hydrogen Atom, X is Sulfonyl, L is from 3 to 4, and all of the Rings A to D are Benzene Rings

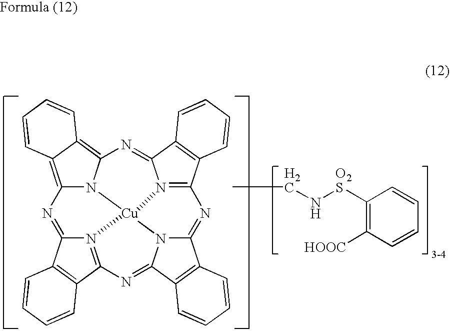

To 80.6 parts of polyphosphoric acid (116%), 5.76 parts of copper phthalocyanine, 12.09 parts of o-sulfobenzimide and 1.98 parts of paraformaldehyde were added, and then the liquid temperature was raised to 140° C. After the reaction was carried out at 140 to 145° C. for 8 hours, the reaction liquid was cooled to 60° C. and 100 parts of water was added thereto to precipitate crystals. The crystals were separated by filtration and washed with 600 parts of water to obtain 47.1 parts of a wet cake. After the obtained wet cake was added to a mixed liquid of 280 parts of water and 3.6 parts of sodium hydroxide and the mixture was reacted at 20 to 25° C. for 6 hours, the reaction liquid was filtered and 36% hydrochloric acid was added to the resulting filtrate to adjust the pH of the filtrate to 1 for precipitation of crystals. The crystals were separated by filtration, washed with 600 parts of water and dried to obtain 12.2 parts of a coloring matter represented by the formula (12) as a blue powder.

### λmax: 675.0 nm, 642.0 nm (in DMF)

### Example 4

### Synthesis of the Coloring Matter Represented by the Following Formula (13)

### The Coloring Matter of the Formula (1) Wherein Y is a Hydrogen Atom, X is Sulfonyl, L is from 4 to 5, and 1.25 of the Rings A to D are Pyridine Rings and the Rest are Benzene Rings

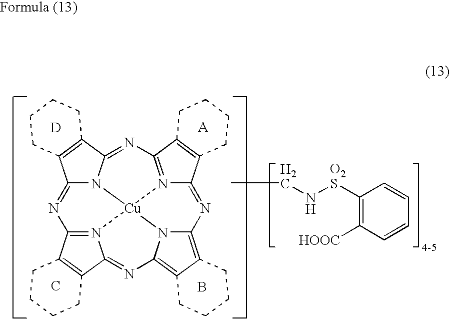

(1) Synthesis of the compound represented by the above formula (6) wherein 1.25 of the rings A to D are pyridine rings and the rest are benzene rings

To a four-neck flask, 250 parts of sulfolane, 20.2 parts of phthalimide, 10.4 parts of quinolinic acid, 72.0 parts of urea, 8.8 parts of copper chloride (II) dihydrate (purity 97.0%) and 1.0 parts of ammonium molybdate were added, the liquid temperature was raised to 200° C. and the mixture was maintained at the same temperature for 5 hours. After completion of the reaction, the reaction liquid was cooled to 65° C., 200 parts of methanol was added thereto and the precipitated crystals were separated by filtration. The obtained crystals were washed with 150 parts of methanol and subsequently with 200 parts of hot water, and dried to obtain 72.5 parts of a wet cake. The whole volume of the obtained wet cake was added to 500 parts of 5% hydrochloric acid, the liquid temperature was raised to 60° C. and the mixture was maintained at the same temperature for 1 hour. The precipitated crystals were separated by filtration and washed with 200 parts of water. Then, the whole volume of the resulting wet cake was added to 500 parts of 10% ammonia water and the liquid temperature was maintained at 60° C. for 1 hour. The precipitated crystals were separated by filtration and washed with 300 parts of water and 100 parts of methanol to obtain 33.3 parts of a wet cake. The obtained wet cake was dried at 80° C. to obtain 19.6 parts of the porphyrazine compound of the above formula (6) as blue crystals.

(2) To 40.3 parts of polyphosphoric acid (116%), 5.76 parts of the porphyrazine compound obtained in Example 4-(1), 16.12 parts of o-sulfobenzimide and 2.64 parts of paraformaldehyde were added, and then the liquid temperature was raised to 140° C. After the reaction was carried out at 140 to 145° C. for 8 hours, the reaction liquid was cooled to 60° C. and 50 parts of water was added thereto to precipitate crystals. The crystals were separated by filtration and washed with 150 parts of water to obtain 13.9 parts of a wet cake. The obtained wet cake was added to a mixed liquid of 70 parts of water and 2.4 parts of sodium hydroxide, and the mixture was reacted at 20 to 25° C. for 6 hours. The reaction liquid was filtered, and 36% hydrochloric acid was added to the resulting filtrate to adjust the pH of the filtrate to 1 for precipitation of crystals. The crystals were separated by filtration, washed with 600 parts of water and dried to obtain 6.25 parts of a coloring matter represented by the above formula (13) as a blue powder.

### λmax: 668.0 nm, 624.0 nm (in DMF)

### Example 5

### Synthesis of the Coloring Matter Represented by the Following Formula (14)

### The Coloring Matter of the Formula (1) Wherein Y is a Hydrogen Atom, X is Carbonyl, L is from 3 to 4, and all of the Rings A to D are Benzene Rings

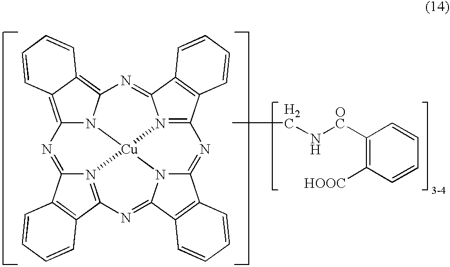

To 40.3 parts of polyphosphoric acid (116%), 2.88 parts of copper phthalocyanine, 3.22 parts of phthalimide and 1.56 parts of paraformaldehyde were added, and then the liquid temperature was raised to 140° C. After the reaction was carried out at 140 to 145° C. for 8 hours, the reaction liquid was cooled to 60° C. and 50 parts of water was added thereto to precipitate crystals. The crystals were separated by filtration and washed with 300 parts of water to obtain 17.3 parts of a wet cake. The obtained wet cake was added to a mixed liquid of 140 parts of water and 2.4 parts of sodium hydroxide, and the mixture was reacted at 20 to 25° C. for 6 hours. The reaction liquid was filtered, and 36% hydrochloric acid was added to the resulting filtrate to adjust the pH of the filtrate to 1 for precipitation of crystals. The crystals were separated by filtration, washed with 300 parts of water and dried to obtain 6.11 parts of a coloring matter represented by the above formula (14) as a blue powder.

### λmax: 679.0 nm, 626.0 nm (in DMF)

### Example 6

### Synthesis of the Coloring Matter Represented by the Following Formula (15)

### The Coloring Matter of the Formula (1) Wherein Y is a Hydrogen Atom, X is Carbonyl, L is from 4 to 5, and 1.5 of the Rings A to D are Pyridine Rings and the Rest are Benzene Rings

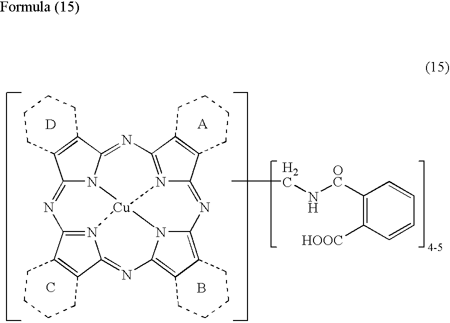

(1) Synthesis of the compound of the above formula (6) where 1.5 of the rings A to D are pyridine rings and the rest are benzene ring

To a four-neck flask, 250 parts of sulfolane, 18.4 parts of phthalimide, 12.5 parts of quinolinic acid, 72.0 parts of urea, 8.8 parts of copper chloride (II) dihydrate (purity 97.0%) and 1.0 parts of ammonium molybdate were added, the temperature was raised to 200° C. and the mixture was maintained at the same temperature for 5 hours. After completion of the reaction, the mixture was cooled to 65° C., 200 parts of methanol was added thereto, and the resulting crystals were filtered. The obtained crystals were washed with 150 parts of methanol and subsequently with 200 parts of hot water and dried to obtain 72.2 parts of a wet cake. The whole volume of the obtained wet cake was added to 500 parts of 5% hydrochloric acid, the temperature was raised to 60° C., and the mixture was maintained at the same temperature for 1 hour. The crystals were filtered and washed with 200 parts of water. Then, the whole volume of the resulting wet cake was added to 500 parts of 10% ammonia water, the mixture was maintained at 60° C. for 1 hour, and the resulting crystals was filtered and washed with 300 parts of water and 100 parts of methanol to obtain 33.6 parts of a wet cake. The obtained wet cake was dried at 80° C. to obtain 19.8 parts of the title compound as blue crystals.

λmax: 663.5 nm (in pyridine)
(2) To 40.3 parts of polyphosphoric acid (116%), 2.89 parts of the porphyrazine compound obtained in Example 6-(1) and 3.90 parts of N-hydroxymethyl phthalimide were added, and then the liquid temperature was raised to 140° C. After the reaction was carried out at 140 to 145° C. for 8 hours, the reaction liquid was cooled to 60° C. and 50 parts of water was added thereto to precipitate crystals. The crystals were separated by filtration and washed with 150 parts of water to obtain 13.9 parts of a wet cake. The obtained wet cake was added to a mixed liquid of 70 parts of water and 2.4 parts of sodium hydroxide, and the mixture was reacted at 20 to 25° C. for 6 hours. The reaction liquid was filtered, and 36% hydrochloric acid was added to the resulting filtrate to adjust the pH of the filtrate to 1 for precipitation of crystals. The crystals were separated by filtration, washed with 600 parts of water and dried to obtain 6.25 parts of a coloring matter represented by the above formula (15) as a blue powder.

### λmax: 656.0 nm, 616.0 nm (in DMF)

### Example 7

### Synthesis of the Coloring Matter Represented by the Following Formula (16)

### The Coloring Matter of the Formula (1) Wherein Y is Carboxy, X is Carbonyl, L is from 3 to 4, and all of the Rings A to D are Benzene Rings

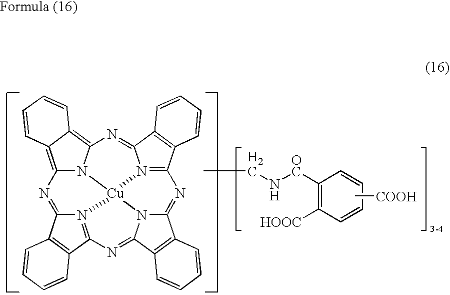

To 40.3 parts of polyphosphoric acid (116%), 2.88 parts of copper phthalocyanine, 6.30 parts of trimellitic acid imide and 0.99 parts of paraformaldehyde were added, and then the liquid temperature was raised to 140° C. After the reaction was carried out at 140 to 145° C. for 8 hours, the reaction liquid was cooled to 60° C. and 50 parts of water was added thereto to precipitate crystals. The crystals were separated by filtration and washed with 300 parts of water to obtain 33.4 parts of a wet cake. The obtained wet cake was added to a mixed liquid of 280 parts of water and 3.6 parts of aqueous sodium hydroxide solution, and the mixture was reacted at 20 to 25° C. for 6 hours. The reaction liquid was filtered, and 36% hydrochloric acid was added to the resulting filtrate to adjust the pH of the filtrate to 1 for precipitation of crystals. The precipitated crystals were separated by filtration, washed with 300 parts of water and then dried to obtain 6.3 parts of a coloring matter represented by the formula (16) as a blue powder.

### λmax: 673.0 nm, 613.0 nm (in DMF)

### Evaluation Examples

### (A) Preparation of Ink

Using the phthalocyanine coloring matter of the present invention obtained in Example 1 described above, an ink composition of the present invention was made by mixing in the composition ratio shown in the following table 2, and then foreign substances were removed away by filtration using a 0.45 μm membrane filter to prepare an ink of the present invention. In this connection, using ion-exchanged water as water, the pH of the ink composition was adjusted with an aqueous ammonia solution to about 9.5 and then water was added to make the total amount 100 parts.

In addition, inks of the coloring matters of the present invention obtained in Examples 2 to 7 were also prepared in the same manner.

TABLE 2

| Composition of Ink | Composition Ratio |
|---|---|
| Phthalocyanine compound | 4.0 parts |
| obtained in Example 1 | |
| Glycerine | 5.0 parts |
| Urea | 5.0 parts |
| N-methyl-2-pyrrolidone | 4.0 parts |
| Isopropylalcohol | 3.0 parts |
| Butyl carbitol | 2.0 parts |
| Trade name: Surfynol 104PG50(Note) | 0.1 part |
| Ammonia water + water | 76.9 parts |
| Total | 100.0 parts |

(Note): Acetylene glycol-based nonionic surfactant, manufactured by Nissin Chemical Industry Co., Ltd.

### Comparative Example 1

As Comparative Example 1, in the same composition ratio as in the table 2 described above except that the coloring matter No. 1 (C.I.Direct Blue 86) as the coloring matter of Patent Literature 1 was used instead of the phthalocyanine compound obtained in Example 1 as a coloring matter component, an ink composition for comparison was prepared and evaluated. The above coloring matter No. 1 used for comparison is a coloring matter having two sulfonic acid groups on average in the phthalocyanine skeleton, and its typical compound is represented by the following formula (19) (the position of the sulfonic acid group is the 3-position).

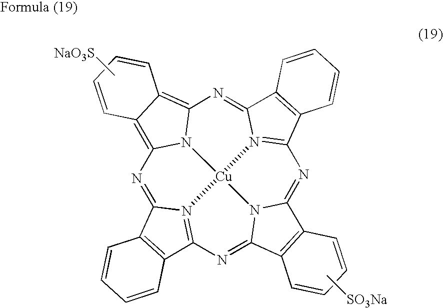

### Comparative Example 2

As Comparative Example 2, a coloring matter where sodium of the coloring matter represented by the above formula (19) was converted to ammonium by salt exchange of the coloring matter used in Comparative Example 1 according to the conventional manner was prepared, and using this, an ink composition for comparison was prepared in the same manner as described above and evaluated.

### (B) Inkjet Printing

Using an inkjet printer (manufactured by Canon Inc., trade name: PIXUS ip4100), inkjet recording was performed on the three kinds of plain paper shown in the table 3. In inkjet recording, a checked pattern (pattern where 1.5 mm-squares having a density of 100% and 1.5 mm-squares having a density of 0% were alternately placed) was made and a cyan-white printed matter having a high contrast was obtained. In addition, an image pattern was also made so that a gradation of several steps in reflection density was obtained, and a gradation printed matter having a density gradation of cyan was obtained.

When judgment by visual observation in water fastness test was conducted, the check patterned printed matter was used.

For measurement of coloring matter residual rate in water fastness test, using the gradation printed matter, measurement of reflection density was conducted in the area where D value as the reflection density of the printed matter before the test had been the nearest 1. In addition, reflection density was measured using a colorimetric system (SpectroEye, manufactured by GretagMacbeth).

The test methods of the recorded images and the evaluation methods of the test results are described below.

TABLE 3

Plain paper 1
Manufactured by Canon Inc.
LBP PAPER LS-500
Plain paper 2
Manufactured by Hewlett Packard
Multipurpose Paper
Plain paper 3
Manufactured by Hewlett Packard
All-in-One Printing Paper

### (C) L*, a* and b* Measurement of Printed Matter

Using the above colorimetric system, the areas having the highest reflection density in the printed gradation printed matters were measured for L*, a* and b* values. The results of each ink composition containing each coloring matter obtained in Examples 1 to 7 are depicted in the table 4, and likewise the results of Comparative Example 1 and the results of Comparative Example 2 are depicted in the table 5 and the table 6, respectively. In addition, the results of cyan hue of Examples and Comparative Examples by visual observation are depicted together.

TABLE 4

| | | | |
|---|---|---|---|
| L* | a* | b* | Hue by visual observation |

Example 1

| | | | | |
|---|---|---|---|---|
| Plain paper 1 | 51.2 | −37.4 | −44.0 | highly vivid |
| Plain paper 2 | 54.3 | −34.6 | −45.3 | highly vivid |
| Plain paper 3 | 54.9 | −34.0 | −44.5 | highly vivid |

Example 2

| | | | | |
|---|---|---|---|---|
| Plain paper 1 | 52.1 | −35.3 | −39.6 | highly vivid |
| Plain paper 2 | 55.2 | −32.4 | −40.6 | highly vivid |
| Plain paper 3 | 56.1 | −32.2 | −40.3 | highly vivid |

Example 3

| | | | | |
|---|---|---|---|---|
| Plain paper 1 | 51.1 | −30.5 | −34.8 | highly vivid |
| Plain paper 2 | 50.3 | −31.4 | −40.2 | highly vivid |
| Plain paper 3 | 49.9 | −32.2 | −41.2 | highly vivid |

Example 4

| | | | | |
|---|---|---|---|---|
| Plain paper 1 | 47.6 | −22.6 | −40.1 | red tinge |
| Plain paper 2 | 48.0 | −23.3 | −45.6 | red tinge |
| Plain paper 3 | 47.9 | −23.5 | −45.8 | red tinge |

Example 5

| | | | | |
|---|---|---|---|---|
| Plain paper 1 | 63.7 | −30.0 | −20.0 | green tinge |
| Plain paper 2 | 64.9 | −30.3 | −25.0 | green tinge |
| Plain paper 3 | 65.2 | −30.2 | −25.2 | green tinge |

Example 6

| | | | | |
|---|---|---|---|---|
| Plain paper 1 | 59.5 | −18.2 | −34.3 | red tinge |
| Plain paper 2 | 61.4 | −16.1 | −36.5 | red tinge |
| Plain paper 3 | 62.1 | −15.7 | −36.0 | red tinge |

Example 7

| | | | | |
|---|---|---|---|---|
| Plain paper 1 | 55.0 | −29.2 | −29.5 | green tinge |
| Plain paper 2 | 56.0 | −28.5 | −32.3 | green tinge |
| Plain paper 3 | 55.9 | −29.1 | −32.9 | green tinge |

TABLE 5
Comparative Example 1

| | L* | a* | b* | Hue by visual observation |
|---|---|---|---|---|
| Plain paper 1 | 45.9 | −35.5 | −42.9 | red tinge |
| Plain paper 2 | 47.8 | −31.6 | −49.7 | red tinge |
| Plain paper 3 | 48.6 | −31.2 | −49.7 | red tinge |

TABLE 6
Comparative Example 2

| | L* | a* | b* | Hue by visual observation |
|---|---|---|---|---|
| Plain paper 1 | 44.5 | −35.6 | −39.7 | red tinge |
| Plain paper 2 | 46.2 | −31.3 | −39.7 | red tinge |
| Plain paper 3 | 47.1 | −31.0 | −49.5 | red tinge |

### (D) Water Fastness Test 1 (Drop Test: Bleeding)

To the printed matter of the checked pattern dried for 24 hours after printing, a drop of ion-exchanged water was added and the printed matter was let dry naturally. After drying, the degree of pattern blurring was evaluated by visual observation and evaluated in 3 levels according to the following criteria.

| | |
|---|---|
| No bleeding (impossible to determine where the drop was added) | ◯ |
| Almost no bleeding (possible to determine where the drop was | Δ |
| added) | |
| Obvious bleeding | X |

The results are shown in the table 7.

### (E) Water Fastness Test 2 (Immersion Test 1: Discoloring and Coloring)

The printed matter of the checked pattern dried for 24 hours after printing was immersed in ion-exchanged water for 1 hour. After drying, the degree of discoloring of the colored area of the pattern and the degree of coloring on the white area were evaluated by visual observation and evaluated in 3 levels according to the following criteria.

| | |
|---|---|
| No discoloring and no coloring | ◯ |
| Discoloring and coloring are slightly observed | Δ |
| Discoloring and coloring are obviously observed | X |

The results are shown in the table 8.

### (F) Water Fastness Test 3 (Immersion Test 2: Coloring Matter Residual Rate)

The gradation printed matter dried for 24 hours after printing was immersed in ion-exchanged water for 1 hour. After drying, the reflection density was measured using the above colorimetric system. After measurement, the coloring matter residual rate was determined by calculation using (reflection density after test/reflection density before test)×100(%) and evaluated in 3 levels according to the following criteria.

| | |
|---|---|
| Coloring matter residual rate is 90% or more | ◯ |
| Coloring matter residual rate is 50% or more and less than 90% | Δ |
| Coloring matter residual rate is less than 50% | X |

The results are shown in the table 9.

TABLE 7
The results of water fastness test 1 (bleeding)

| | (Plain paper 1) | (Plain paper 2) | (Plain paper 3) |
|---|---|---|---|
| Example 1 | Δ | ◯ | ◯ |
| Example 2 | ◯ | ◯ | ◯ |
| Example 3 | ◯ | ◯ | ◯ |
| Example 4 | ◯ | ◯ | ◯ |
| Example 5 | ◯ | ◯ | ◯ |
| Example 6 | ◯ | ◯ | ◯ |
| Example 7 | ◯ | ◯ | ◯ |
| Comparative | X | X | X |
| Example 1 | | | |
| Comparative | X | X | X |
| Example 2 | | | |

TABLE 8
The results of water fastness test 2 (discoloring and coloring)

| | (Plain paper 1) | (Plain paper 2) | (Plain paper 3) |
|---|---|---|---|
| Example 1 | Δ | ◯ | ◯ |
| Example 2 | ◯ | ◯ | ◯ |
| Example 3 | ◯ | ◯ | ◯ |
| Example 4 | ◯ | ◯ | ◯ |
| Example 5 | ◯ | ◯ | ◯ |
| Example 6 | ◯ | ◯ | ◯ |
| Example 7 | ◯ | ◯ | ◯ |
| Comparative | X | X | X |
| Example 1 | | | |
| Comparative | X | X | X |
| Example 2 | | | |

TABLE 9
The results of water fastness test 3 (coloring matter residual rate)

| | (Plain paper 1) | (Plain paper 2) | (Plain paper 3) |
|---|---|---|---|
| Example 1 | Δ | Δ | Δ |
| Example 2 | ◯ | ◯ | ◯ |
| Example 3 | ◯ | ◯ | ◯ |
| Example 4 | ◯ | ◯ | ◯ |
| Example 5 | ◯ | ◯ | ◯ |
| Example 6 | ◯ | ◯ | ◯ |
| Example 7 | ◯ | ◯ | ◯ |
| Comparative | X | X | Δ |
| Example 1 | | | |
| Comparative | X | X | Δ |
| Example 2 | | | |

As is clear from the results in the tables 7 to 9, for Comparative Examples 1 and 2, bleeding (water fastness test 1) was obviously observed and also discoloring and coloring (water fastness test 2) were obviously observed in the water fastness tests, and in addition, any of the coloring matter residual rates on plain papers 1 and 2 is less than 50%, which shows that the water fastness is poor in any of the tests except that their coloring matter residual rates on plain paper 3 are a little good.

On the other hand, for the inks of Examples of the present invention, the extremely good results were obtained in any of water fastness tests 1 to 3 for all of plain papers 1 to 3 (only the ink of Example 1 is a little good for coloring matter residual rate), whereby it is found that their water fastness in plain paper is extremely high.

In addition, as is clear from the table 4, the coloring matter represented by the above general formula (1) of the present invention can give change in hue of the obtained coloring matter by appropriately selecting X and the rings A to D in said formula. That is, when all of the rings A to D are benzene rings, the cyan coloring matter which is highly vivid and near its standard color is obtained if X is a sulfonyl group, and the cyan coloring matter having green-tinged hue is obtained if X is a carbonyl group. Further, when a pyridine ring is included in the rings A to D (Examples 4 and 6), the cyan coloring matter having red-tinged hue is obtained whichever X is a sulfonyl group or a carbonyl group.

Therefore, the intended cyan coloring matter such as a cyan coloring matter near its standard color, a green-tinged cyan coloring matter, a red-tinged cyan coloring matter and the like can be obtained by appropriately changing the structure for any purpose.

Judging from the results mentioned above, the water-soluble phthalocyanine compound of the present invention is suitable for preparation of ink compositions for inkjet recording and extremely excellent in various fastnesses, particularly in water fastness, and in addition, has a high water-solubility and a good and vivid hue. From these characteristics, it is found that the phthalocyanine compound of the present invention is a very useful compound as an ink coloring matter for various recordings, particularly as a cyan coloring matter for inkjet ink.

1. An ink composition containing a coloring matter represented by the following formula (1), or a salt thereof: 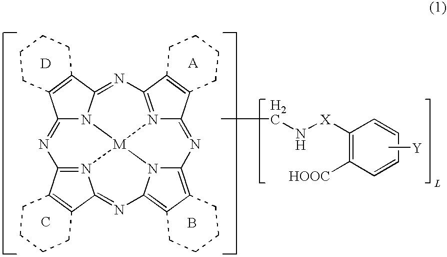
(wherein, each of the rings A to D shown with dotted lines independently represents a benzene ring or a pyridine ring, and at least one or more thereof is a benzene ring,
M represents a hydrogen atom, a metal atom, a metal oxide, a metal hydroxide or a metal halide,
X represents a carbonyl group or a sulfonyl group,
Y represents a hydrogen atom; a nitro group; a hydroxy group; a sulfo group; a carboxy group; an amino group (which may have, as a substituent, one or more kinds of groups selected from the group consisting of an aryl group, a heteroaryl group, an alkyl group, an alkoxy group, an alkylsulfonyl group, an alkylthio group, an arylamino group, a diarylamino group, a heteroarylamino group, a diheteroarylamino group, an alkylamino group, a dialkylamino group, a sulfo group, a carboxy group, a phosphono group, a sulfamoyl group, a carbamoyl group, a hydroxy group, an amino group, an acetylamino group, an ureide group, a nitro group, a cyano group and a halogen atom); a group selected from the group consisting of an alkoxy group, an alkylthio group and an alkylsulfonyl group, which may have, as a substituent, one or more kinds of groups selected from the group consisting of an aryl group, a heteroaryl group, an alkoxy group, an alkylsulfonyl group, an alkylthio group, an arylamino group, a diarylamino group, a heteroarylamino group, a diheteroarylamino group, an alkylamino group, a dialkylamino group, a sulfo group, a carboxy group, a phosphono group, a sulfamoyl group, a carbamoyl group, a hydroxy group, an amino group, an acetylamino group, an ureide group, a nitro group, a cyano group and a halogen atom; or a group selected from the group consisting of an aryloxy group, an arylthio group, an arylsulfonyl group, a heteroaryloxy group, a heteroarylthio group and a heteroarylsulfonyl group, which may be substituted by one or more kinds of substituents selected from the group consisting of an alkyl group, an alkoxy group, an alkylsulfonyl group, an alkylthio group, an arylamino group, a diarylamino group, a heteroarylamino group, a diheteroarylamino group, an alkylamino group, a dialkylamino group, a sulfo group, a carboxy group, a phosphono group, a sulfamoyl group, a carbamoyl group, a hydroxy group, an amino group, an acetylamino group, an ureide group, a nitro group, a cyano group and an a halogen atom, as a substituent, and
L is from 2 to 8,
respectively).

2. The ink composition according to claim 1, wherein the coloring matter represented by the formula (1) or a salt thereof is a coloring matter represented by the following formula (111), or a salt thereof: 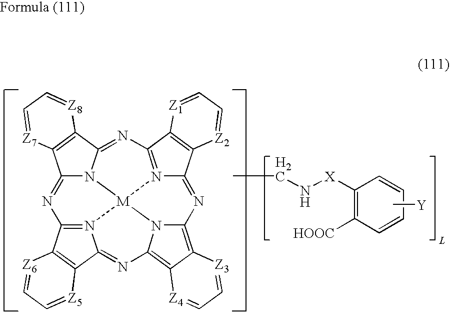
(wherein, M represents a hydrogen atom, a metal atom, a metal oxide, a metal hydroxide or a metal halide,
X denotes a carbonyl group or a sulfonyl group,
Y represents a hydrogen atom or a carboxy group,
L is from 2 to 8,
each of Z₁ to Z₈ independently represents a nitrogen atom or a carbon atom, where at least one of the four combinations, Z₁ and Z₂, Z₃ and Z₄, Z₅ and Z₆ and Z₇ and Z₈, is a combination of carbon atoms and none of the above combinations is a combination of nitrogen atoms).

3. The ink composition according to claim 1 or 2, wherein M is a copper atom.

4. The ink composition according to claim 1 or 2, which further contains an organic solvent.

5. The ink composition according to claim 1 or 2, which is for inkjet recording.

6. An inkjet recording method characterized by using the ink composition according to claim 1 or 2 as an ink or using an ink set comprising the ink composition in an inkjet recording method in which an ink drop is discharged responding to a recording signal to carry out recording on a record-receiving material.

7. The inkjet recording method according to claim 6, wherein the record-receiving material is a communication sheet.

8. An ink container containing the ink composition according to claim 1 or 2.

9. An inkjet printer having the ink container according to claim 8.

10. A colored product colored with the ink composition according to claim 1 or 2.

11. A coloring matter represented by the following formula (2), or a salt thereof: 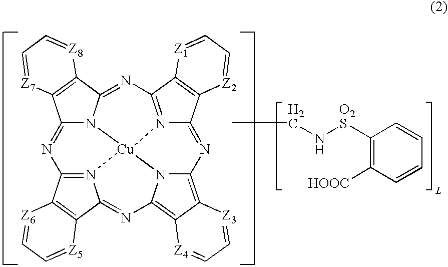
(wherein, L is from 2 to 8,
each of Z₁ to Z₈ independently represents a nitrogen atom or a carbon atom, where at least one of the four combinations, Z₁ and Z₂, Z₃ and Z₄, Z₅ and Z₆, and, Z₇ and Z₈, is a combination of carbon atoms and none of the above combinations is a combination of nitrogen atoms).

12. The ink composition containing the coloring matter or a salt thereof according to claim 11.

13. The ink composition according to claim 11, which further contains an organic solvent.

14. A colored product colored with the coloring matter according to claim 11 or a salt thereof or with the ink composition according to claim 12 or 13.
